(19) United States
(12) Patent Application Publication
(10) Pub. No.: US 2022/0351313 A1
(43) Pub. Date: Nov. 3, 2022

(54) Systems and Methods for Monitoring, Maintaining and Upgrading a Property

(71) Applicant: vipHomeLink, LLC, Morristown, NJ (US)

(72) Inventors: Alfred Young Bentley, III, Morristown, NJ (US); Geoffrey Ellis Martin, Mount Pleasant, SC (US)

(21) Appl. No.: 17/865,829

(22) Filed: Jul. 15, 2022

Related U.S. Application Data
(63) Continuation-in-part of application No. 17/840,344, filed on Jun. 14, 2022.
Application No. 17/840,344 is a continuation-in-part of application No. 16/276,544, filed on Feb. 14, 2019, now abandoned.
(60) Provisional application No. 62/631,014, filed on Feb. 15, 2018.

(51) Int. Cl. G06Q 50/16; G06F 3/0482; G06F 3/0484; G06Q 10/00; G06Q 10/06; G06Q 30/02

(52) U.S. Cl. CPC G06Q 50/163; G06F 3/0482; G06F 3/0484; G06Q 10/20; G06Q 10/06393; G06Q 30/0206

(57) ABSTRACT

Systems and methods are described for monitoring, maintaining and upgrading a property. A property fitness index tracks a maintenance of at least one property using at least one fitness metric. A property value for the property is determined and a property value boost for the property is determined using the property fitness index for the property. A property log auto-populates a property log for the property with recorded actions related to the property and associated dates for the recorded actions. The recorded actions may be categorized by improvements, maintenance or home issues.

### CROSS-REFERENCE TO RELATED APPLICATIONS

This application claims the benefit under 35 U.S.C. § 120 as a continuation in part application to the U.S. Published Application No. 2019/0251520, entitled, “Systems and Methods for Monitoring, Maintaining and Upgrading a Property,” filed on Feb. 14, 2019, and having Ser. No. 16/276,544 (the '544 Application), which is hereby incorporated by reference in its entirety as if fully set forth herein. The '544 Application claims the benefit of the U.S. provisional patent application entitled “System and method for tracking, reporting, and analyzing home-based information,” having Ser. No. 62/631,014, filed Feb. 15, 2018, which is hereby incorporated by reference in its entirety as if fully set forth herein.

### COPYRIGHT NOTICE

A portion of the disclosure of this patent document contains material which is or may be subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### BACKGROUND OF THE INVENTION

It is known for websites to merge input from listing services with identifiable features of a property, such as condition, distance from schools, number of bedrooms, etc., to calculate property values. Also known is using sensors to monitor a property to alert a user of incidents with the property that would need to be addressed and set up inspections and work orders. Other systems can determine a risk value for a property based on the type of building, zoning, and sensors and provide cost estimates to users for enhancement. Yet other systems provide service management instructions for maintenance and repair of a property.

The most common approach for tracking property information and making recommendations is for a property owner to manually track all updates and perform scheduled maintenance. Unfortunately, this takes a great deal of time and effort, a reasonable knowledge of the workings of a home, significant effort, and often results in lost, misplaced, incomplete, or biased records. A more effective solution may be a formal property inspection such as those performed by a licensed home inspector, a property appraiser, a contractor, or the like. Unfortunately, this approach is often cost prohibitive and does not provide an on-going history and tracking of the property to uncover and/or proactively predict and forecast new issues. The result of these approaches is that properties are less safe by virtue of being maintained to a lesser standard and could be less valuable than those properties whose users utilize the embodied invention. Further, these approaches do not provide notifications or alerts for the user, immediate insights, or recommendations based on evidence-based or predictive analytics.

Conventional approaches to determining, tracking and assessing the safety or condition of a property have significant disadvantages. For instance, properties are generally assessed for safety or condition once, or rarely, (for example, during a home inspection that occurs prior to the purchase of a home). However, the conditions which influence safety or value change more frequently and should be tracked more regularly. Accordingly, the assessment of the safety or condition of the property may only be accurate for a short time after an initial inspection; after which time the assessed safety of the property might rapidly diverge from the actual level of safety. For that reason, the safety assessment can only be considered valid for a short period of time, and properties outside of that short time window likely no longer have an accurate safety (or condition) assessment.

In the alternative, taking an approach of regular periodic safety and condition inspections would be cost prohibitive, time consuming, and would require regular physical access to a property by a third party. Additionally, the existing modality of property inspections is more focused on assessment of need for improvement or deficient conditions and less focused on proactive, preventative, and/or on-going recommendations of measures to increase the safety of the property. Additionally, the safety assessment, and the quality of the assessment, can be influenced by the subjectivity of the assessor. It should also be noted that many home inspection licenses disallow home inspectors from providing a full assessment on the present safety or lack of safety at a home.

### BRIEF SUMMARY OF THE INVENTION

Briefly stated, in one aspect of the present invention, disclosed is a system for managing maintenance of at least one property. A computing device having a processing unit, the processing unit operatively coupled to a non-transitory computer readable medium, comprising instructions stored thereon, which, when executed by the processing unit, causes the computing device to perform the steps of: creating or updating at least one fitness metric for the at least one property; determining a property fitness index of the at least one property using the at least one fitness metric; determining a property value for the property; determining a property value boost for the property using the property value for the property and the property fitness index for the property; and generating a graphical user interface (GUI) for display including the property value boost for the property.

Briefly stated, in another aspect of the present invention, disclosed is a system for managing maintenance of at least one property. A computing device having a processing unit, the processing unit operatively coupled to a non-transitory computer readable medium, comprising instructions stored thereon, which, when executed by the processing unit, causes the computing device to perform the steps of: determining a property fitness index of the at least one property; determining a property value for the property and a range of the property value using property value data, wherein the property value data is obtained by one or more of: accessing at least one public database or receiving input from a user; determining a property value boost for the property using the property value for the property, the range for the property value and the property fitness index for the property; and generating a graphical user interface (GUI) for display including the property value boost for the property.

Briefly stated, in another aspect of the present invention, disclosed is a system for managing maintenance of at least one property. A computing device having a processing unit, the processing unit operatively coupled to a non-transitory computer readable medium, comprising instructions stored thereon, which, when executed by the processing unit, causes the computing device to perform the steps of: determining user input into the system, wherein the user input indicates an action relating to a property; auto-populating a property log for the property with the action and an associated date for the action; receiving user notes in a GUI relating to the property and storing the user notes with an associated date in the property log; and generating a GUI of a historical report for the property, wherein the GUI includes a listing by date of at least the property maintenance action and the user notes relating to the property.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 depicts a flow chart depicting a login and initial display of the property fitness index process in accordance with one embodiment of the present invention;

FIG. 2 depicts a Dashboard screen display in accordance with one embodiment of the present invention;

FIG. 3 depicts a flow chart depicting calculation of a property fitness index according to an exemplary embodiment of the present invention;

FIG. 4 depicts an exemplary update profile screen display in accordance with one exemplary embodiment of the present invention;

FIG. 5 depicts an exemplary flow chart depicting the steps to update a profile according to one exemplary embodiment of the present invention;

FIG. 6 depicts an exemplary flow chart depicting the steps to view a profile according to one exemplary embodiment of the present invention;

FIG. 7 depicts an exemplary view profile screen display in accordance with one exemplary embodiment of the present invention;

FIG. 8 depicts an exemplary suggestions screen display in accordance with one exemplary embodiment of the present invention;

FIG. 9 depicts an exemplary flow chart depicting the steps to view suggestions according to one exemplary embodiment of the present invention;

FIG. 10 depicts an exemplary flow chart depicting the steps to view and update a member profile according to one exemplary embodiment of the present invention;

FIG. 11 depicts an exemplary member profile screen display in accordance with one exemplary embodiment of the present invention;

FIG. 12 depicts an exemplary member profile sub-field information screen display in accordance with one exemplary embodiment of the present invention;

FIG. 13 depicts an exemplary journal screen display in accordance with one exemplary embodiment of the present invention;

FIG. 14 depicts an exemplary flow chart depicting the steps to view and update a journal page according to one exemplary embodiment of the present invention;

FIG. 15 depicts options for user behaviors, user engagement, property states, and property traits according to one exemplary embodiment of the present invention;

FIG. 16 depicts an exemplary flow chart for tracking items in a property via a sensor, tracking and rewording user behavior, and incorporating same into a property fitness index in accordance with one exemplary embodiment of the present invention;

FIG. 17 depicts an exemplary flow chart for creating and managing sub-accounts in accordance with one exemplary embodiment of the present invention;

FIG. 18 depicts an exemplary account management screen display according to one exemplary embodiment of the present invention;

FIG. 19 depicts an exemplary subaccount management screen display according to one exemplary embodiment of the present invention;

FIG. 20 depicts an exemplary data input screen display for adding a new subaccount to a profile according to one exemplary embodiment of the present invention;

FIG. 21 depicts an exemplary account management screen display according to one exemplary embodiment of the present invention;

FIG. 22 depicts a flow chart of a profile sharing process in accordance with one embodiment of the present invention;

FIG. 23 depicts a block diagram of an exemplary computing device in accordance with an embodiment of the present disclosure; and

FIG. 24 depicts a schematic view of an exemplary network environment in accordance with an embodiment of the present disclosure.

FIG. 25 depicts an exemplary a property value boost screen display according to one exemplary embodiment of the present invention;

FIG. 26 depicts a flow chart of a property value boost process according to one exemplary embodiment of the present invention;

FIG. 27 depicts an exemplary property value boost recommendations screen display according to one exemplary embodiment of the present invention;

FIG. 28 depicts a flow chart of a recommendations process according to one exemplary embodiment of the present invention;

FIG. 29 depicts an exemplary property value boost summary report screen display according to one exemplary embodiment of the present invention;

FIG. 30 depicts a flow chart of a property value boost summary report process according to one exemplary embodiment of the present invention;

FIG. 31 depicts a property log screen display according to one exemplary embodiment of the present invention; and

FIG. 32 depicts a flow chart of a property log process according to one exemplary embodiment of the present invention.

### DETAILED DESCRIPTION OF THE INVENTION

The subject application references certain processes which are presented as series of ordered steps. It should be understood that the steps described with respect to those processes are not to be understood as enumerated consecutive lists but could be performed in various orders while still embodying the invention described herein.

Where a term is provided in the singular, the inventors also contemplate aspects of the invention described by the plural of that term. As used in this specification and in the appended claims, the singular forms “a”, “an” and “the” include plural references unless the context clearly dictates otherwise, e.g., “an appliance” may include a plurality of appliances. Thus, for example, a reference to “a method” includes one or more methods, and/or steps of the type described herein and/or which will become apparent to those persons skilled in the art upon reading this disclosure.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods, constructs and materials are now described. All publications mentioned herein are incorporated herein by reference in their entirety. Where there are discrepancies in terms and definitions used in references that are incorporated by reference, the terms used in this application shall have the definitions given herein.

Various embodiments of the present invention provide methods, executable by an application or program resident on a computing device and/or in a computing system environment, to monitor, assess and maintain a property. A user, generally a property owner, but can be a landlord, a prospective buyer, property manager, or other stakeholder, can access the system from a laptop computer, a desktop computer, a mobile device or other suitable device.

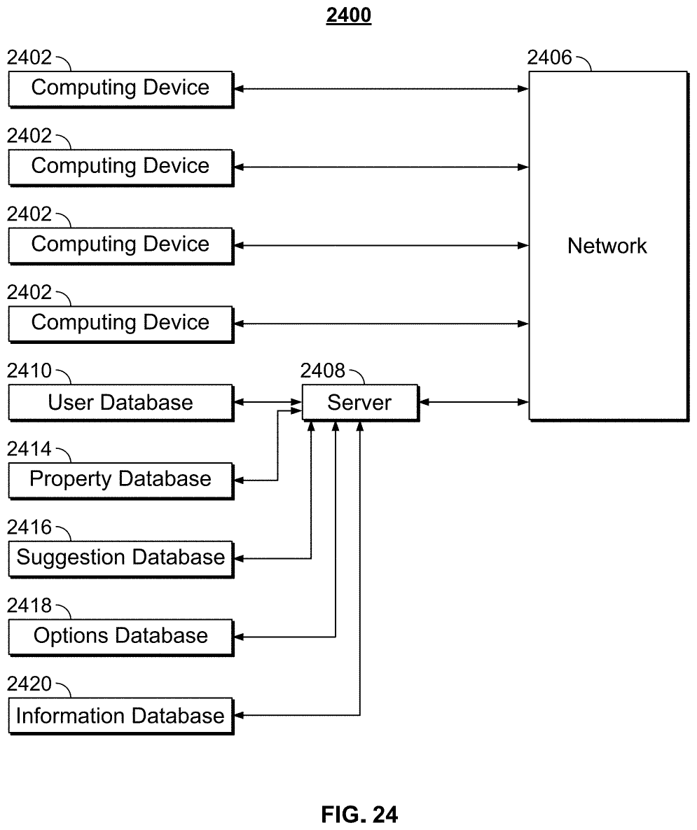

Referring now to FIG. 24, depicted is an exemplary computing system environment for allowing a user of system 2400 to perform the methods described herein. The depicted computing system environment is only one example of a suitable computing environment and is not intended to suggest any limitation as to the scope of use or functionality. Numerous other general purpose or special purpose computing system environments or configurations may be used. Examples of well-known computing systems, environments, and/or configurations that may be suitable for use include, but are not limited to, personal computers (“PCs”), server computers, handheld or laptop devices, multi-processor systems, microprocessor-based systems, network PCs, minicomputers, mainframe computers, cell phones, tablets, embedded systems, distributed computing environments that include any of the above systems or devices, and the like.

Computer-executable instructions such as program modules executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

In the depicted embodiment, exemplary system 2400 includes, inter alia, one or more computing devices 2402 and one or more servers 2408 with corresponding databases, such as user database 2410, property database 2414, suggestion database 2416, options database 2418, and information database 2420. The servers and databases shown in FIG. 24 are merely exemplary, and servers and/or databases may be omitted, added, or substituted without departing from the scope of the present invention. It should be noted that in the depicted embodiment, server 2408 has the same configuration as computing device 2402 as described in further detail herein. Further, databases 2410, 2414, 2416, 2418, and 2420 may be combined into a single database and/or may be included in the respective servers without departing from the scope hereof. It should also be appreciated that one or more databases, including databases 2410, 2414, 2416, 2418, and 2420 may be combined, provided in or distributed across one or more of computing devices 2402, dispensing with the need for servers such as server 2408 altogether.

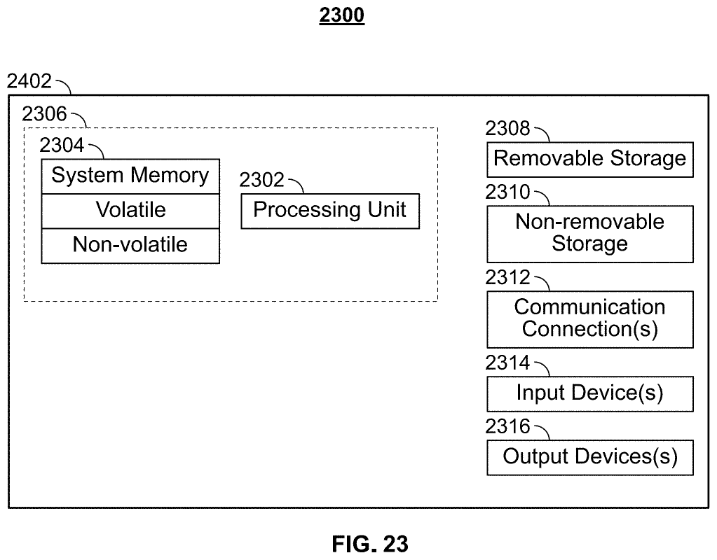

In its most basic configuration, as depicted in FIG. 23, computing device 2402 includes at least one processing unit 2302 and at least one memory 2304. Depending on the exact configuration and type of the computing device, memory 2304 may be volatile (such as random-access memory (“RAM”), non-volatile (such as read-only memory (“ROM”), flash memory, etc.), or some combination of the two. This most basic configuration is illustrated in FIG. 23 by dashed lines 2306. In addition to that described herein, computing devices 2402 can be any web-enabled handheld device (e.g., cell phone, smart phone, watch, or the like) or personal computer including those operating via Android™, Apple®, and/or Windows® mobile or non-mobile operating systems.

Computing device 2402 may have additional features/functionality. For example, computing device 2402 may include additional storage (removable and/or non-removable) including, but not limited to, magnetic or optical disks or tape, thumb drives, and external hard drives as applicable. Such additional storage is illustrated in FIG. 23 by removable storage 2308 and non-removable storage 2310.

Computing device 2402 typically includes or is provided with a variety of computer-readable media. Computer-readable media can be any available media that can be accessed by computing device 2402 and includes both volatile and non-volatile media, removable and non-removable media. By way of example, and not limitation, computer-readable media may comprise computer storage media and communication media.

Computer storage media includes volatile and non-volatile, removable and non-removable media implemented in any method or technology for storage of information such as computer-readable instructions, data structures, program modules or other data. Memory 2304, removable storage 2308, and non-removable storage 2310 are all examples of computer storage media. Computer storage media includes, but is not limited to, RAM, ROM, electrically erasable programmable read-only memory (“EEPROM”), flash memory or other memory technology, CD-ROM, digital versatile disks (“DVD”) or other optical storage, magnetic cassettes, magnetic tape, magnetic disk storage or other magnetic storage devices, cloud devices, or any other medium which can be used to store the desired information, and which can accessed by computing device 2402. Any such computer storage media may be part of computing device 2402 as applicable.

Computing device 2402 may also contain communications connection 2312 that allows the device to communicate with other devices. Such communications connection 2312 is an example of communication media. Communication media typically embodies computer-readable instructions, data structures, program modules and/or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (“RF”), infrared and other wireless media. The term computer-readable media as used herein includes both storage media and communication media.

Computing device 2402 may also have input device(s) 2314 such as keyboard, mouse, pen, voice input device, touch input device, etc., for receiving input from a user. In an embodiment, a voice input device is a smart speaker. Output device(s) 2316 such as a display, speakers, printer, etc. may also be included. All these devices are generally known to the relevant public and therefore need not be discussed in any detail herein except as provided.

Notably, referring back to FIG. 24, computing device 2402 may be one of a plurality of computing devices 2402 inter-connected by network 2406. As may be appreciated, network 2406 may be any appropriate network and each computing device 2402 may be connected thereto by way of connection 2312 in any appropriate manner, and each computing device 2402 may communicate with one or more of the other computing devices 2402 via network 2406 in any appropriate manner. For example, network 2406 may be a wired network, wireless network, or a combination thereof within an organization or property or the like and may include a direct or indirect coupling to an external network such as the Internet or the like. Likewise, network 2406 may be such an external network including, without limitation, the Internet. In the exemplary embodiments shown herein, network 2406 is the Internet and allows the multiple systems necessary to implement the systems and methods discussed herein to communicate data quickly and efficiently. However, alternate networks and/or methods of communicating information may be substituted without departing from the scope hereof.

Computing device 2402 may connect to the various servers via such an internal or external network. Although FIG. 24 depicts computing device 2402 located in close proximity to servers 2408, 2412, this depiction is not intended to define any geographic boundaries. For example, when network 2406 is the Internet, computing device can have any physical location. For example, computing device may be a tablet, cell phone, personal computer, or the like located at any user's office, home, etc. Or computing device could be located proximate to one or more servers without departing from the scope hereof. Also, although FIG. 24 depicts computing devices 2402 coupled to server 2408 via network 2406, computing devices may be coupled directly to one or more servers via any other compatible networks including, without limitation, an intranet, local area network, or the like.

The depicted embodiment of system 2400 may use a standard client server technology architecture, which allows users of system 2400 to access information stored in the databases via custom user interfaces. In some embodiments of the present invention, the processes are hosted on one or more servers which are accessible via the Internet using a publicly addressable Uniform Resource Locator (“URL”) For example, users can access exemplary system 2400 using any web-enabled device equipped with a web browser. Communication between software component and sub-systems are achieved by a combination of direct function calls, publish and subscribe mechanisms, stored procedures, and direct SQL queries, however, alternate components, methods, and/or sub-systems may be substituted without departing from the scope hereof. Also, alternate embodiments are envisioned in which a computing device 2402 directly accesses one or more servers through a private network rather than via the Internet and a URL.

Computing devices 2402 may be equipped with one or more Web browsers to allow them to interact with one or more servers and/or databases via a Hypertext Transfer Protocol (“HTTP”). HTTP functions as a request-response protocol in client-server computing. For example, a web browser operating on computing device 2402 may execute a client application that allows it to interact with applications executed by the one or more servers. The client application submits HTTP request messages to the one or more servers. The corresponding servers, which provide resources such as HTML files and other data or content, or performs other functions on behalf of the client application, returns a response message to the client application upon request. The response typically contains completion status information about the request as well as the requested content. However, alternate methods of computing device/server communications may be substituted without departing from the scope hereof including those that do not utilize the Internet for communications.

Computing Devices 2402 may additionally host apps specifically designed to access one or more servers and/or databases in order to allow a user or stakeholder to use the system.

In the exemplary system 2400, the databases may include a plurality of databases and/or database tables. As may be appreciated, the databases may be any appropriate database capable of storing data, including without limitation cloud-based databases, and may be included within or connected to one or more servers similar to those described herein in any appropriate manner without departing from the scope hereof.

It should be understood that the various techniques described herein may be implemented in connection with hardware or software or, as appropriate, with a combination of both. Thus, the methods and apparatus of the presently disclosed subject matter, or certain aspects or portions thereof, may take the form of program code (i.e., instructions, scripts, and the like) embodied in tangible media, such as floppy diskettes, CD-ROMs, hard drives, flash drives, DVDs or any other machine-readable storage medium wherein, when the program code is loaded into and executed by a machine, such as a computer, the machine becomes an apparatus for practicing the presently disclosed subject matter.

In the case of program code execution on programmable computers, the interface unit generally includes a processor, a storage medium readable by the processor (including volatile and non-volatile memory and/or storage elements), at least one input device, and at least one output device. One or more programs may implement or utilize the processes described in connection with the presently disclosed subject matter (e.g., through the use of an application-program interface (“API”), reusable controls, or the like). Such programs may be implemented in a high-level procedural or object-oriented programming language to communicate with a computer system. However, the program(s) can be implemented in assembly or machine language, if desired. In any case, the language may be a compiled or interpreted language, and combined with hardware implementations.

Although exemplary embodiments may refer to utilizing aspects of the presently disclosed subject matter in the context of one or more stand-alone computer systems, the subject matter is not so limited, but rather may be implemented in connection with any computing environment, such as system 2400 or other distributed computing environment. Still further, aspects of the presently disclosed subject matter may be implemented in or across a plurality of processing chips or devices, and storage may similarly be affected across a plurality of devices in system 2400. Such devices might include personal computers, network servers, and handheld devices (e.g., cell phones, tablets, smartphones, etc.), for example.

The system of the present invention facilitates a property owner's management of his or her property by providing the user the ability to track, curate, analyze, report and notify based on best practices and existing conditions. In one aspect of the present invention, the system presents to the property owner a property fitness index or score of the property that is calculated from various metrics. For example, these metrics may include criteria such as, but not limited to, the property owner's behavior relative to the property, the level of engagement of the property owner with the system and methods of the present invention, current states of the property, and current traits of the property. And, each of these metrics may be based on multiple variables.

Embodiments of the present invention relate generally to property maintenance, property improvement, home condition, and property assessment, which are critical activities to the value and safety of properties including, without limitation, real estate properties or a home. More specifically, the present invention relates to a system and method for a property owner and associated stakeholders (such as an insurance company) to discover opportunities or threats to a property's safety or value. By tracking and understanding elements of a property's states (current conditions) or traits (inherent elements of a property), the property owner and stakeholders can address deficient conditions. For example, property owners can better maintain their properties. Also, insurance companies can better assess risks for potential insureds by assessing the potential insured's risk profile and make recommendations to such insureds assuming the property owner has consented to providing the company with certain information or has consented to an explicit data sharing arrangement. And, property sellers can provide a history of a property and associated activities and behaviors to prospective buyers of the property.

In one aspect of the present invention, a system tracks property and system data from a multitude of sources, provides the user or an agent with raw and structured access to this data, provides the user or an agent with analytics and reporting at all levels of data collection, and provides insights and prompts to track additional updates, activities or user behaviors. The system output includes, but is not limited to, structured reporting and notifications via email, push alerts, and other electronic means. The system inputs include automatic data collection from devices, sensors, APIs, other associated systems, as well as user or agent provided information. This system and its associated algorithms may operate on any appropriate computer platform.

In light of the challenges of acquisition and management of property-related information as discussed above, a new approach to track, curate, analyze, and/or report data and/or to notify users that is more actionable and more representative of the current state of a property would provide significant utility and value to all stakeholders associated with a property. The approach employed by the systems and methods of the present invention to determine the states and traits of a property does not depend on the property having recently been formally inspected, and it can be used to accurately assess the states and traits of any property. Additionally, these systems and methods of the present invention may be implemented without the added cost, or inherent subjectivity, or lack of consistency, of a formal property inspection. The result is a more consistent and accurate representation of the states and traits of a property complemented by the longitudinal insight and real-time recommendations provided by the system.

According to an embodiment, a user creates a profile on the system with user information and information about one or more properties. Each of these properties will be associated with a property profile that stores information about the property. A property profile may include, but is not limited to, information about the property's traits, states, or items in or on the property and/or parts associated with such items.

A user may first interact with the systems and methods of the present invention via a computing device 2402, such as that shown in FIG. 23 and described herein, by creating a secure user profile with a login and password. The systems and methods of the present invention may store this user profile in, for example, user database 2410. Profile information can also be entered into the system by the user, the property owner, a partner, a stakeholder, or combinations thereof, that describes information about, for example, the property and the user. Such information may be manually input or automatically input via a system interface. A partner can be, for example, an insurance carrier, and in an embodiment, the information submitted by the insurance carrier is derived from an insurance application of the carrier. In some embodiments, the information presented to the system by a stakeholder can be about items which may include, but are not limited to, appliances or other items found on the property. By way of example, one of the computing devices 2402 can be an insurance carrier computer that interfaces with the system network in an environment such as that shown in FIG. 24 via an API or the like to automatically input/retrieve information to/from the system.

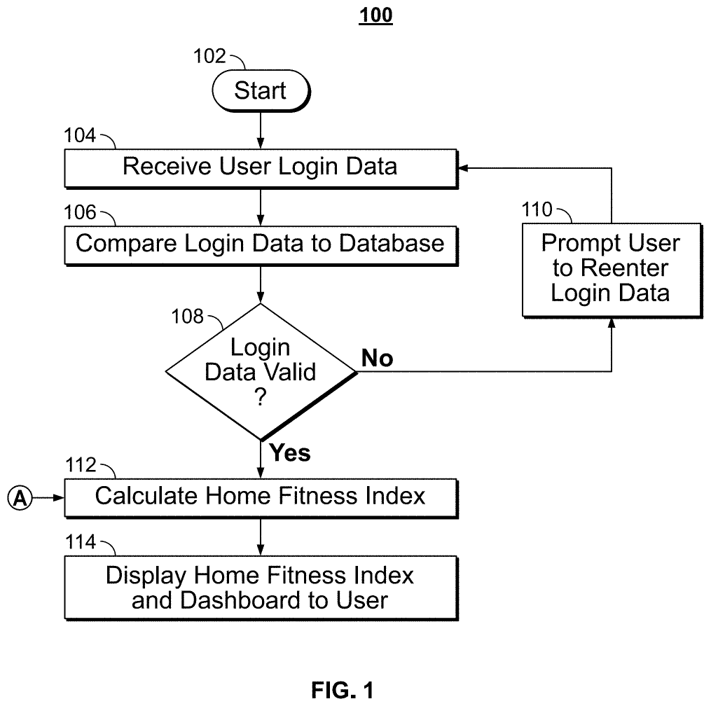

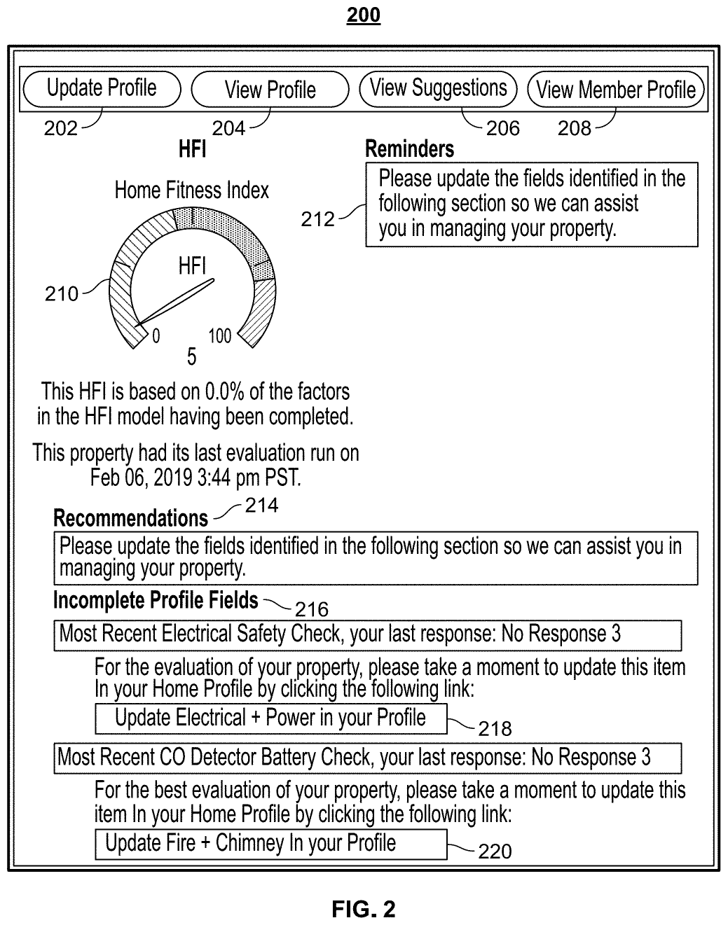

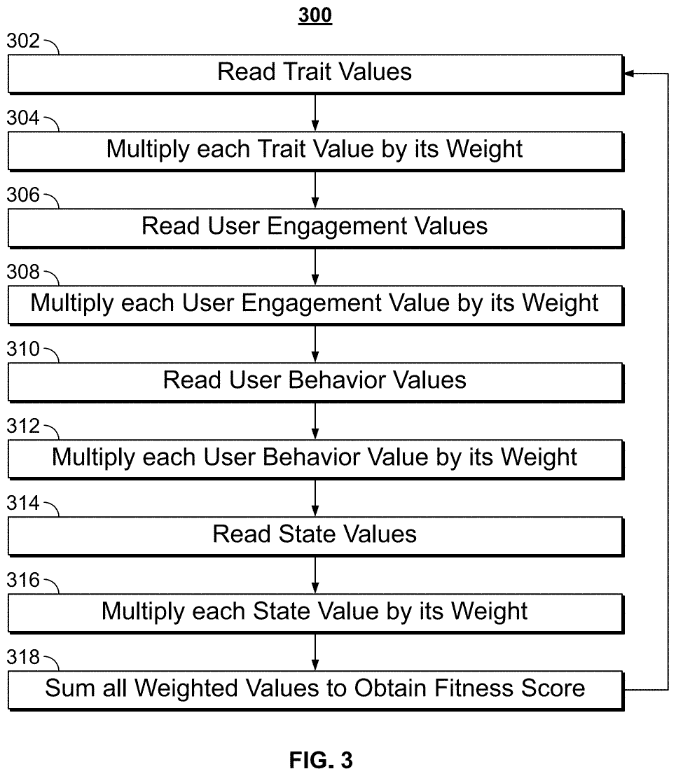

Turning now to FIG. 1, depicted is a flow chart of a login and initial property fitness Index process 100 in accordance with one embodiment of the present invention. At Step 102, the system is engaged by a user that has previously set up a user profile including, for example, a user name and password. At Step 104, the system receives login data from the user. At Step 106, the system compares the login data to information about the user's profile such as the data stored in user database 2410. If the login data does not match the data associated with the corresponding user profile, as stored in user database 2410, process 100 proceeds to Step 110 and prompts the user to re-enter the login data. If the login data matches the data associated with the corresponding user profile, then process 100 proceeds to Step 112, at which it calculates a Property Fitness Index for each of the one or more properties associated with the user profile. One such process for calculating a Property Fitness Index is described below in FIG. 3. In Step 114, the system displays the Property Fitness Index and a Dashboard (such as Dashboard 200 as shown in FIG. 2) to the user.

FIG. 2 depicts Dashboard 200 in accordance with an embodiment of the present invention. Dashboard 200 prominently displays the Property Fitness Index 210, calculated, in an embodiment, according to the process depicted in FIG. 3. In the shown embodiment, the property type is a single-unit home, but it is envisioned that the property type can be any type of property including, but not limited to, homes, vehicles, boats, airplanes, businesses, multi-unit residences, housing complexes, or any other type of dwelling. Dashboard 200 displays various information including a list of reminders 212, a list of recommendations 214, and a list of property sub-fields 216 that have not been completed by the user or are overdue.

Reminders 212 may be time-sensitive and can include anything required to optimize the Property Fitness Index, which has not yet been performed by a user such as, but not limited to, updating information about the property, actions to take regarding the property, and the like.

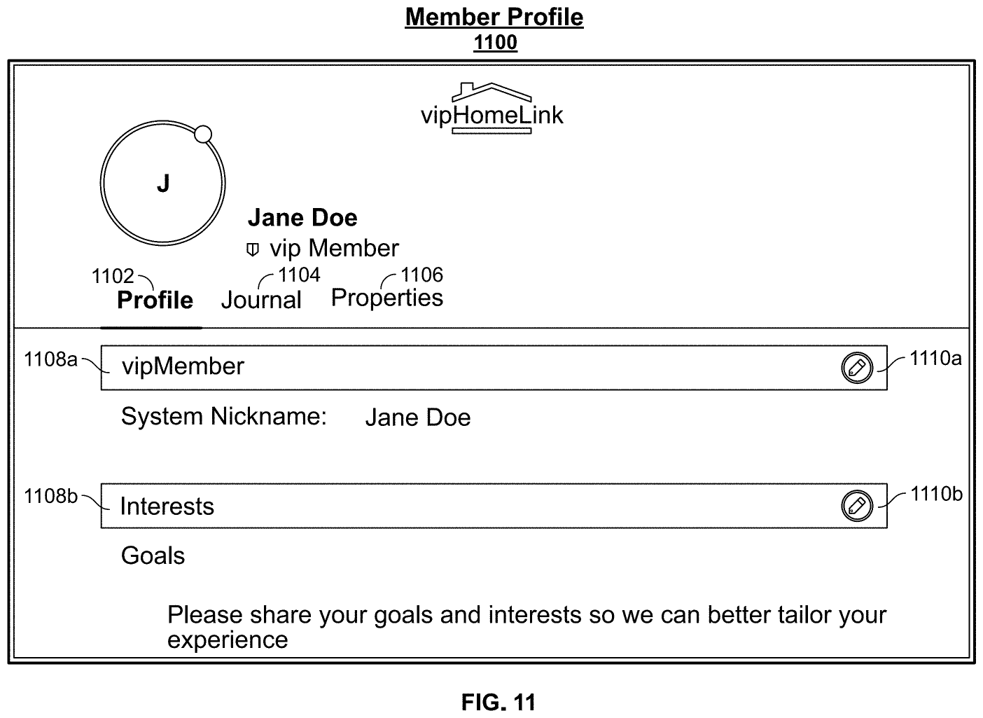

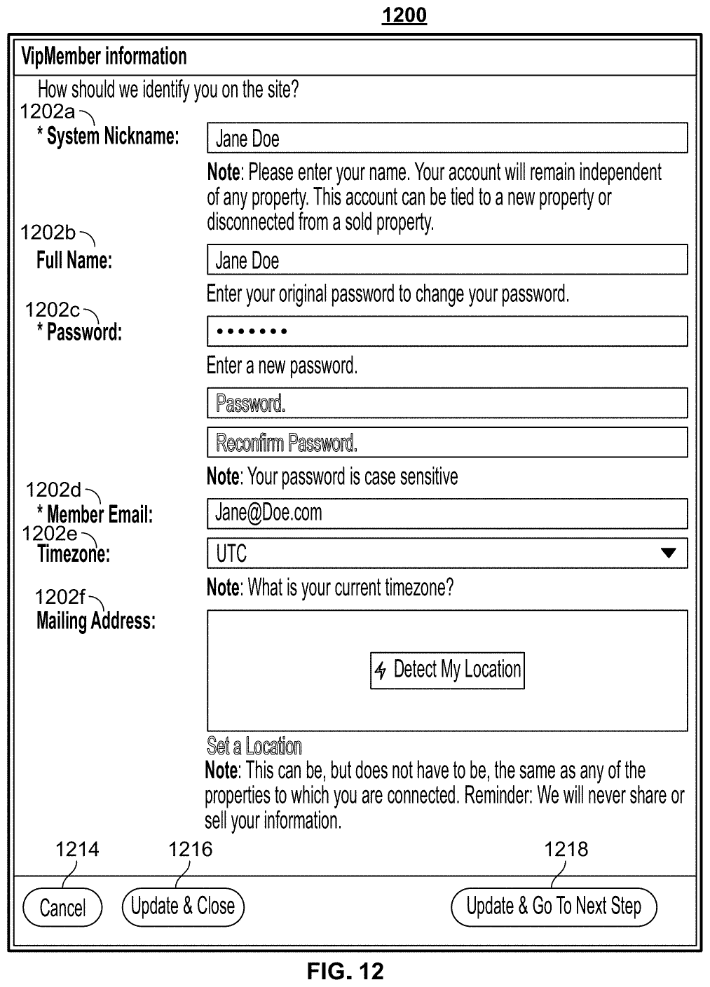

The list of recommendations 214 may include recommendations such as, but not limited to, non-time-sensitive improvements, safety recommendations, value recommendations, qualitative recommendations, quantitative recommendations, and any combination thereof. These recommendations may be based on data reported by the user (self-reported data), information reported by the system, meta-data, user-defined preferences and categories, or geographical or property-specific classifications, or any combination thereof. For example, a user answering affirmatively for the presence of a safety item such as a generator would trigger one set of recommendations versus a user answering in the negative, which would trigger a different set of recommendations. That is, answering in the an illative may prompt the systems and methods of the present invention to provide maintenance and/or upgrade suggestions for the specific generator, whereas answering in the negative may prompt the systems and methods of the present invention to recommend installation of a generator as an upgrade item. In an embodiment, user-defined preferences are set up in the member profile page, an example of which is depicted in FIG. 11. Recommendations tailored to the user based on these preferences can then be provided to the user. For example, a user who has set a preference that indicates that he or she is not interested in Do-It-Yourself (DIY) projects (as indicated in the interests section of the member profile) will not receive recommendations for DIY projects, but may receive recommendations for local contractors.

The recommendations can also include actionable insights, which are based on specific user feedback and user supplied data, are tailored, specific and immediately actionable, and can be directed towards the user or a partner. In an embodiment, the system stores an exhaustive list of thresholds and associated alert types (and language strings) in a table in a database. When the dashboard (or other output) for the user is being prepared, user values are compared against the thresholds. If a threshold is exceeded, the system will provide the user the associated notification or alert using the associated language string as stored in the database. Alternatively, the text of the notification or alert can be dynamically generated. The user then can take action to resolve the issue. The system is told that issue has been resolved either automatically through a sensor or manually by the user or someone else with access to the system.

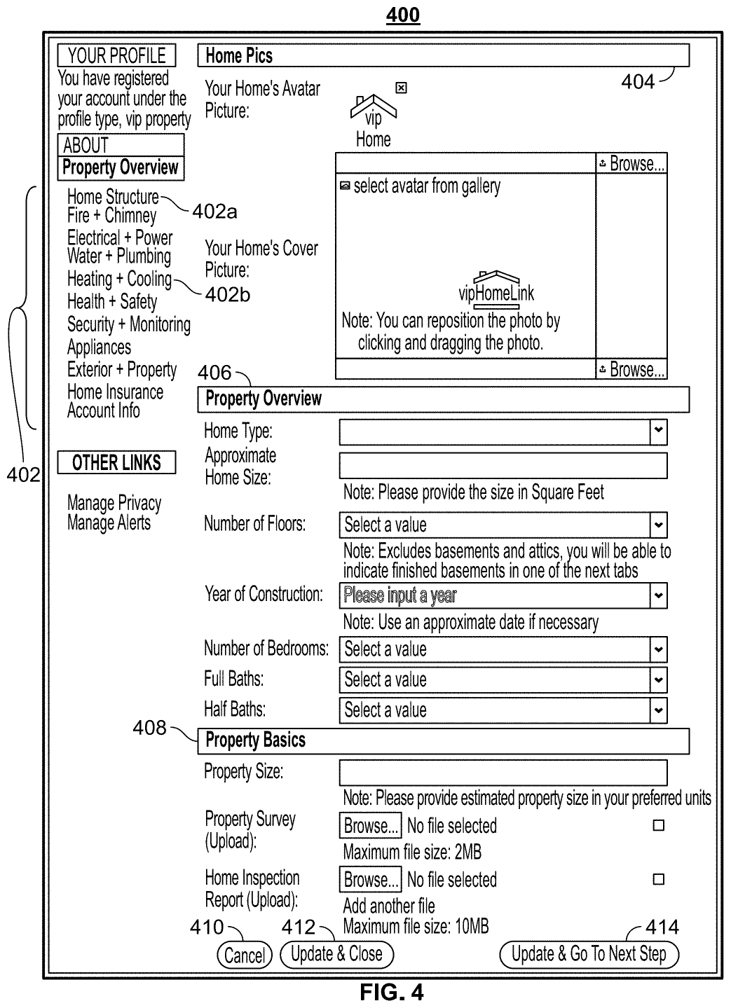

As depicted, and as available in an embodiment, the user is also prompted to update any overdue fields (i.e., a field that has not been updated within the predetermined time criteria set within the system). The user may update such overdue fields by simply clicking on the prompts. In dashboard 200, these prompts are labelled “Update Electrical and Power in your Profile” and “Update Fire and Chimney in your Profile,” however, these prompt labels will change based upon the behavior of the user and/or the characteristics and items of the property. Or, such prompts may not be displayed at all if a user is fully up to date with all information. A user may address any deficiencies by simply clicking the respective prompt, for example prompt 218 or 220, and entering the updated information. Other potential prompts include, but are not limited to, other property-information sub-fields such as Property Structure, Water and Plumbing, Heating and Cooling, Health and Safety, Security and Monitoring, Appliances, Exterior and Property, Property insurance and Account Information. It should be noted that these property information sub-fields may also be accessed through an update profile screen such as update profile screen 400 as depicted in FIG. 4.

In the depicted embodiment of the present invention, from Dashboard 200, the user is presented with four options: Update Profile 202, View Profile 202, View Suggestions 206, and View Member (User) Profile 208. However, alternate embodiments are envisioned in which options are omitted, added, and/or substituted without departing from the scope of the present invention.

In order to update the profile, the user can click on the Update Profile button 202 from the Dashboard. In other embodiments, the update profile screen can be accessed in other ways, such as from a global menu.

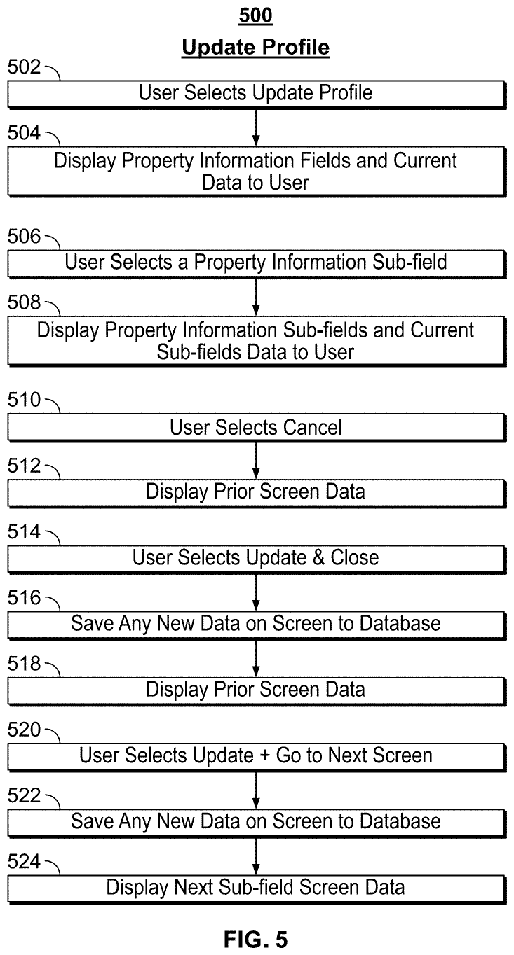

Turning now to FIGS. 4 and 5, depicted are an exemplary user profile update page 400 and flowcharts of the upgrade profile processes 500, respectively. Upgrade profile processes 500 may be executed by a user from an upgrade profile screen such as exemplary upgrade profile screen 400 in accordance with one embodiment of the invention. Step 502 is executed when the user clicks on the Update Profile Button 202 from Dashboard 200, causing property information fields and current data to be displayed at Step 504, an example of which is shown in FIG. 4 as upgrade profile page 400. For example, upgrade profile page 400 may include, but is not limited to, property pictures 404, property overview 406, property basics 408, and property information sub-fields links 402. In the depicted embodiment, the property information sub-fields include Property Structure, Fire and Chimney, Electrical and Power, Water and Plumbing, Heating and Cooling, Health and Safety, Security and Monitoring, Appliances, Exterior and Property, Property Insurance and Account Information. However, sub-fields may be omitted, added, and/or substituted without departing from the scope hereof.

Upon a user selecting a property information sub-field 402, step 506 of process 500 is executed, which prompts step 508 to be executed, which displays the property information sub-field and current sub-field data to the user at Step 508. When the user reaches the desired sub-field, he or she can manually edit the information or enter new information in the sub-fields. In Step 510, if the user has made a mistake in entering sub-field information, he or she can select the Cancel button 410, causing the prior screen to be shown at Step 512. If the user is satisfied with the changes, at Step 514 the user can either select the Update & Close button 412 or the Update & Go To Next Step button 414. At Steps 516 and 522, any new data that was entered is saved to the database. If the Update & Close button 412 was selected, flow proceeds from 516 to Step 518, at which the prior screen is shown to the user. If the Update & Go To Next Step button 414 was selected, flow proceeds from 522 to 524, at which the screen associated with the data and current information for the next sub-field in the list is shown to the user at Step 524. In an embodiment, the user is able to update his or her profile via survey or direct feedback instead of entering it directly.

In an embodiment, the system classifies profile data as either “required,” “option al,” or “categorical.” After the user updates the profile, the system performs a completeness assessment, in which the completed items are compared to the in completed items to provide a completion index, which can be a percentage score) for the “required,” “optional,” or “categorical” responses. In an embodiment, the completeness index or assessment can be run manually at any time.

In an embodiment, pre-defined questions can be presented to a user, stakeholder or partner in the form of a survey. The survey-taker can access the survey from the system or via a link. Responses to the survey are either mapped to existing profile fields or can completely overwrite existing fields. These fields may be updated the next time the user logs into the system.

The answers to these fields can be used as input to any of the models described herein. Survey questions can include, but are not limited to: how do you feel about your home?; how do you feel about homes in general?; how do you feel about your relationship with your current home or prior home?; why did you buy your home?; why did you buy vs. rent?; how long did you plan to be in your home?; what were the conditions surrounding purchase?; would you define yourself as one who likes to do-it-yourself or pay-someone-else?; what are you interested in learning more about?; how well do you know your home?; how well would you like to know your home?; materials use in deck?; approximate size of deck?; if wood deck, what is the brand of coating?; if wood deck, what is the type of coating?; if wood deck, when was the last time painted, stained, or sealed?; driveway?; driveway material?; driveway installation date?; last driveway seal or service date?; years in home?; HVAC location?; HVAC size?; last time HVAC changed?; last time HVAC ducts cleaned?; who cleaned the HVAC ducts?; how much did the HVAC duct cleaning cost?; type of heating systems?; type of electrical systems?; is there pest control for the property?; when was the last time pest control serviced the property?; when does the contract with the pest control servicer renew?, garbage and recycling information?; cost of trash removal?; date of trash removal?; type of trash removal?; cost of recycling removal?; date of recycling removal?; type of recycling removal?; landscaping?; irrigation?; irrigation coverage?; lawn treatment service?; law spraying?; lawn cutting service?; mulching?; landscaper name?; landscaper contact number?; paint and finishes?; water service?; water filters water softener?; water filtration system?; auto water shut off information?; cleaning service?; cleaning service company name?; beginning of cleaning service contract?; current pricing of cleaning service?; pool information?; safety check information?; safety check information—hoses for washing machine?; safety check information—dryer line cleaning?; safety check information—chimney sweep?; hot water heater information?; sump pump information?; window information?, tax information?; is there a deck?; what is in the home?; and what has been done to the home?.

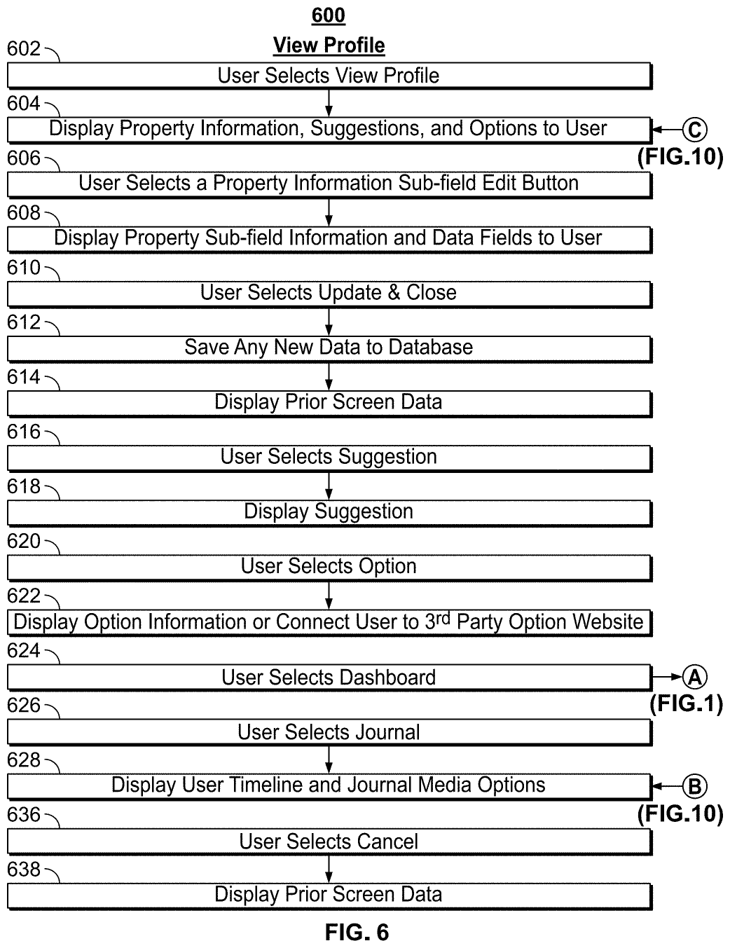

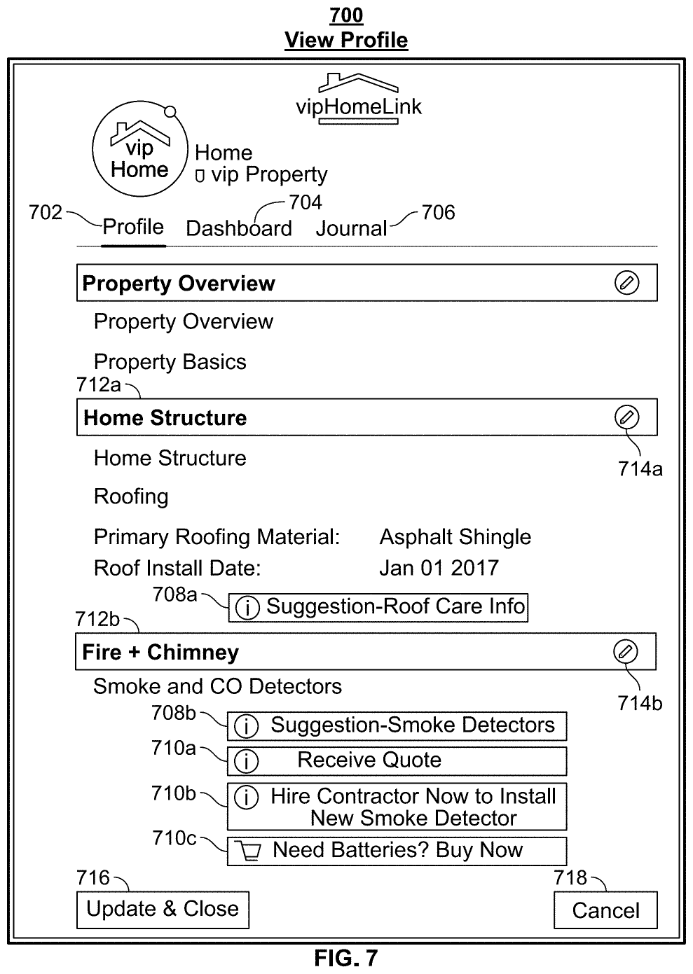

Referring back to Dashboard 200, the user can also select View Profile button 204 by clicking this button with a mouse or the like. Referring now to FIGS. 6 and 7, depicted are an exemplary flow chart depicting the steps to view a profile and an exemplary view profile page, respectively, in accordance with one exemplary embodiment of the present invention.

Selection of view profile button 204 causes Step 602 of process 600 to be executed as shown in FIG. 6. Process 600 then proceeds to Step 604, at which the property information, suggestions and options are displayed to the user as depicted in the exemplary display screen 700, shown in FIG. 7. This exemplary screen includes property information sub-fields 712, suggestions 708, and options 710a-c. From screen 700, a user can select a property information sub-field edit button such as 714a or 714b, which will cause Step 606 to be executed. Process 600 then proceeds to 608, at which property sub-field information and data fields 400 are displayed to the user. At this point, the user can make changes to the data fields on the screen 700 via an input device.

User selection of suggestion buttons 708a-08b for a particular suggestion subcategory triggers Step 616 of process 600, which proceeds to Step 618, at which one or more suggestions are displayed to the user.

User selection of option buttons such as button 710A—710c triggers Step 622 of process 600, which proceeds to step 622, at which point information is displayed about an option or the user is connected to a third-party website to obtain an option. In an embodiment, an option is receiving a quote for a part or contractor to repair or maintain an item currently on the property. In an embodiment, the user can click on option button 710c to instantly purchase a part required to upgrade or maintain an item currently on the property. In yet another embodiment, an option to hire a contractor to perform an upgrade and/or maintenance on an item or to install a new item is provided.

Envisioned is an option that is activated with a single click on option button 710b, for example, to hire a contractor. By clicking once on option button 710b, the system contacts a recommended contractor to come to the property to install or maintain an item. In the shown embodiment, a contractor is hired to install a new smoke detector; however, contractors may be hired to install, maintain, and/or upgrade other items. In another embodiment, the user can click on option button 710a to receive one or more quotes from contractors to perform maintenance, upgrade, or installation of items, Other options may be added, deleted, or substituted without departing from the scope hereof.

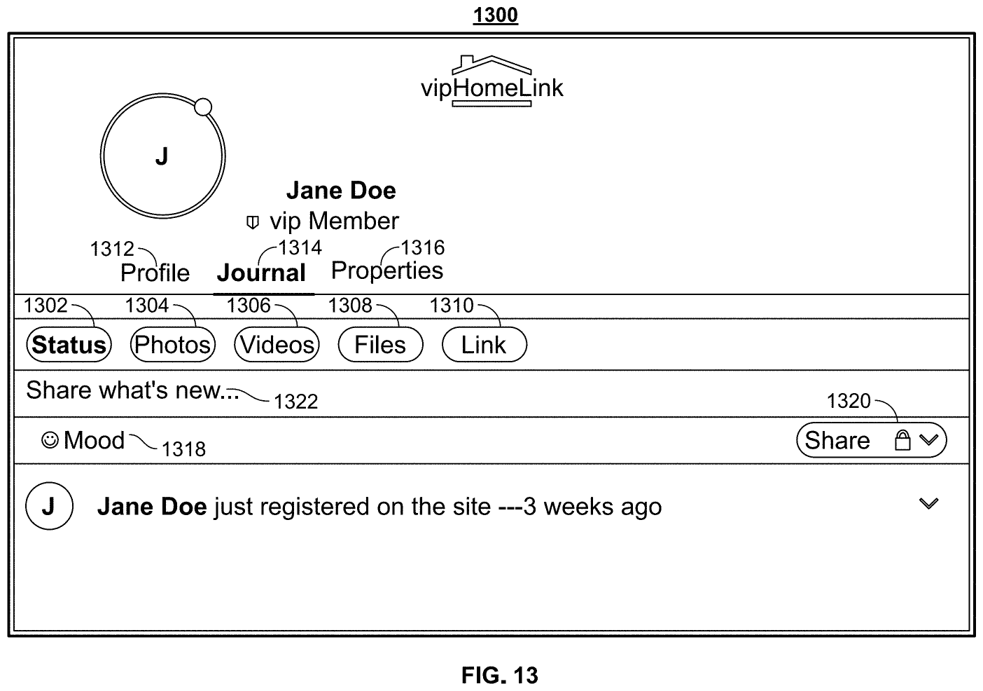

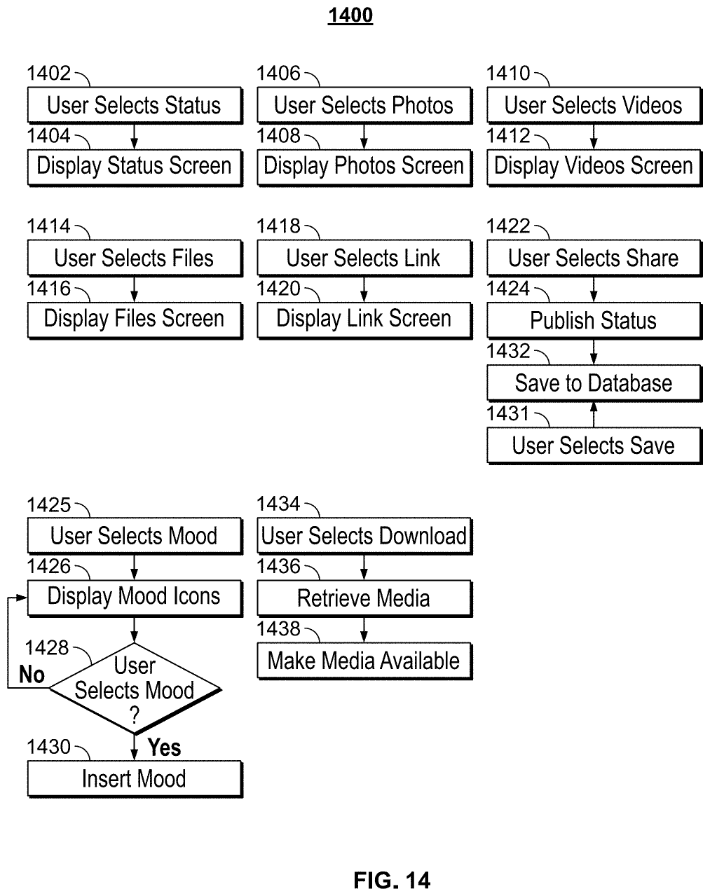

From the View Profile screen 700, the user can choose to go back to the Dashboard at Step 624 by clicking Dashboard button 704, which displays Dashboard 200 to the user. Also, at screen 700, the user can select the Journal button by clicking it, which executes Step 626. Next, at Step 628, process 600 displays a user timeline and journal media options. The journal page and its operation are described below with respect to FIGS. 13 and 14, respectively.

In Step 636, if the user has made a mistake in entering sub-field information or does not wish to alter the information, he or she can select the Cancel button 718, which executes Step 636 and then 638, which causes the prior screen to be shown at Step 638. If the user is satisfied with the changes, the user can select the Update & Close button 716, which executes Step 610 of process 600. Next, at step 612, any new data that was entered is saved to the database and flow proceeds to Step 614, at which the prior screen is shown to the user.

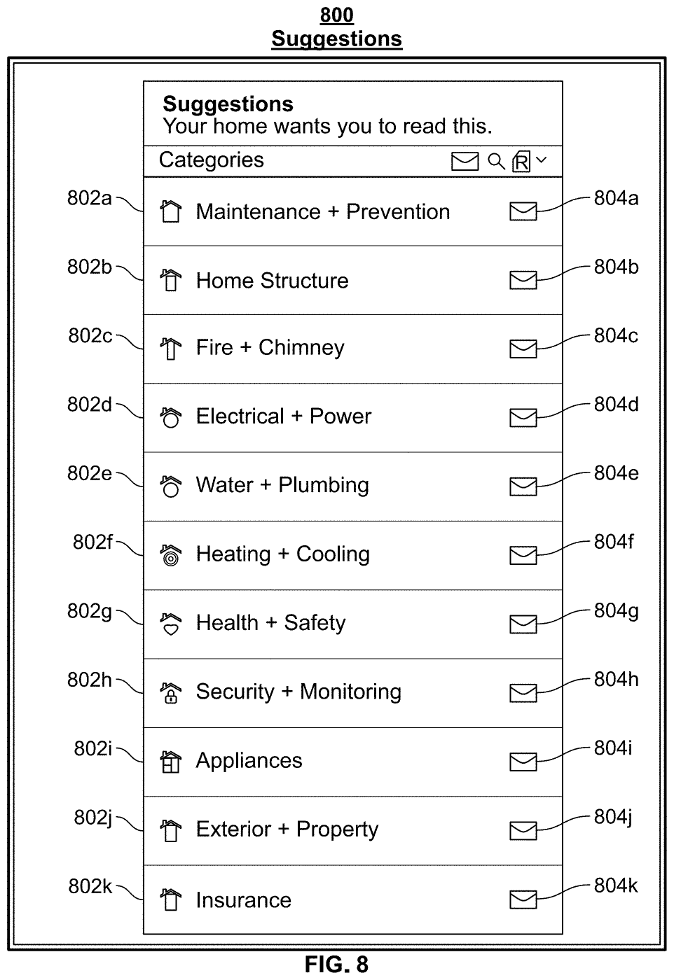

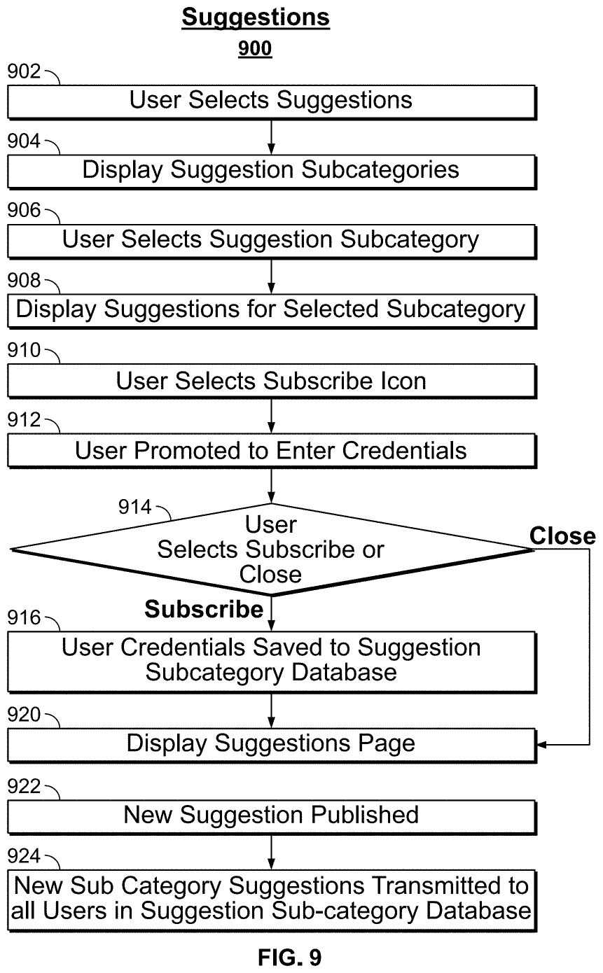

Referring now to FIGS. 8 and 9, depicted are an exemplary suggestions page and an exemplary flow chart depicting the steps to view suggestions, respectively, according to one exemplary embodiment of the present invention. In an embodiment, Suggestions can include general knowledge of a topic, or information related to maintenance or upgrade of items. For example, a Suggestion can include, but is not limited to, smoke detector testing and maintenance tips, instructions for replacing an air filter, instructions for installing a new water heater, and the like. The suggestions page may be accessed, for example, when a user selects the Suggestions button 206 from Dashboard 200 (See FIG. 2). This causes execution of Step 902, after which process 900 proceeds to Step 904, at which it displays a Suggestion page with suggestion subcategories to a user. One such exemplary page is shown as page 800 in FIG. 8.

From Suggestions page 800, a user can select a Suggestions subcategory by clicking or otherwise accessing a suggestion subcategory button 802a-k, which cases Step 906 to be executed. Process 900 then proceeds to Step 908, which causes the system to display the selected Suggestions subcategory page to the user. In an embodiment, the Suggestions subcategory is displayed in blog format, however, in alternate embodiments, other formats, such as a PDF, web page, or any other way of presenting text and images, are envisioned.

In the depicted embodiment, suggestions screen 800 also includes a plurality of subscribe buttons 804a-804k. Selecting a subscribe button triggers execution of Step 910, which causes the system to prompt the user to enter credentials at Step 912. Credentials may include, for example, email address, system username, cell phone number, or the like. Process 900 then proceeds to step 914, at which the user is prompted to select close or subscribe. If the user wishes to exit without subscribing, she can select a close button at Step 914, and process 900 proceeds to Step 920, at which the initial Suggestions page 800 is again displayed to a user. Alternatively, if at Step 914 the user selects subscribe, process 900 proceeds to step 916, at which the user's credentials are saved to suggestion subcategory database 2416. Next, at Step 920, the user is returned to the initial Suggestions page 800. In the depicted embodiment, when a new suggestion is posted to a suggestion subcategory, step 922 is triggered. Thereafter, process 900 proceeds to Step 924, at which the new suggestion is transmitted to the credentials of all users who are listed in the suggestion subcategory database 2416 as being subscribed to that suggestion subcategory.

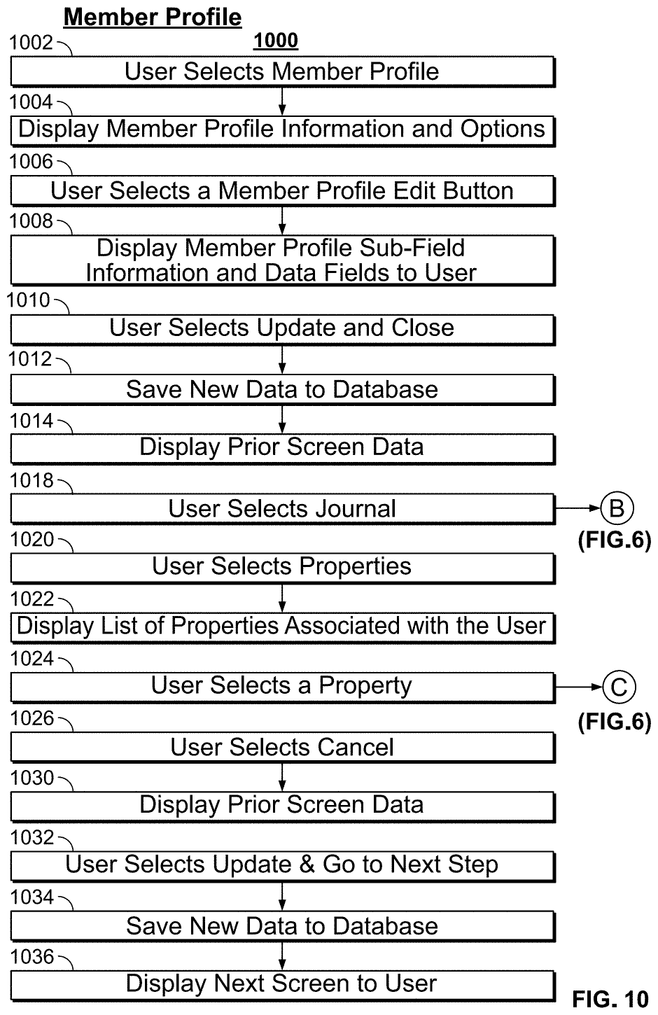

Referring now to FIGS. 10 and 11, depicted are an exemplary flow chart depicting the steps to view and update a member profile page and an exemplary member profile page, respectively, according to one exemplary embodiment of the present invention. The member profile page may be accessed, for example, when a user selects the view member profile button 208 from Dashboard 200 (See FIG. 2). This causes execution of Step 1002, after which process 1000 proceeds to Step 1004, at which it displays a member profile information and options page to a user. One such exemplary page is shown as page 1100 in FIG. 11. In the depicted embodiment, as shown in FIG. 11, page 1100 shows various information about the user.

Upon selection of a user profile edit button 1110a or interests edit button 1110b, step 1006 is triggered, after which process 1000 proceeds to Step 1008. Step 1008 displays the corresponding subfield information for the edit button selected by the user. For example, screen 1200 depicts an exemplary user profile edit sub-field information in accordance with one embodiment of the invention. At screen 1200, the user can choose to update any of the data fields 1202a-1202f to update or otherwise change information fields including, but not limited to, user nickname, full name, password, email address, time zone, and mailing address. If the user has made a mistake in entering sub-field information, she can select the Cancel button 1214; thereby triggering Step 1026 and subsequently step 1030, the latter causing the prior screen to be again displayed to the user. Or, if the user is satisfied with the changes, he or she may select the Update & Close button 1216 or the Update & Go To Next Step button 1218, thereby triggering steps 1010 and 1032, respectively. Process 1000 proceeds from step 1010 to step 1012, at which any new data that was entered is saved to the corresponding database such as user database 2410. Thereafter, process 1000 proceeds to step 1014, at which the prior screen is displayed to the user. Alternatively, if the Update & Go To Next Step button 1218 is selected, process 1000 proceeds from step 1032 to step 1034, at which any new data that was entered is saved to the corresponding database such as user database 2410. Thereafter, process 1000 proceeds to step 1036, at which the next screen is displayed to the user. In the depicted embodiment, the next screen may be the interests edit subfield information screen, however alternate next screens may be substituted without departing from the scope of the present invention.

From screen 1100, the user can also select Journal button 1104, thereby executing Step 1018. Process 1000 then proceeds to process 1400, as shown in FIG. 14 and as described in greater detail below. Or, at screen 1100, the user also has the option of selecting a Properties button 1106; which triggers execution of Step 1020. Process 1000 then proceeds to step 1022, at which process 1000 displays a list of properties associated with the user. Selection of a property from this list executes Step 1024. Process 1000 then proceeds to process 600, as shown in FIG. 6 and as described in greater detail herein.

Referring now to FIGS. 13 and 14, depicted are an exemplary journal page and an exemplary flow chart depicting the steps to view and update a journal page, respectively, according to one exemplary embodiment of the present invention. The Journal page 1300 may be accessed, for example; when a user selects the journal button 1104 from member profile screen 1100 (See FIG. 11). This causes execution of Step 1018 (FIG. 10), after which Step 1404 is executed, which displays a journal page to a user. One such exemplary journal page is shown as page 1300 in FIG. 13. In the depicted embodiment, as shown in FIG. 13, page 1300 show various options to allow a user to upload various types of media.

At journal screen 1300, a user may select a status button 1302, thereby causing process 1400 to execute step 1402. Process 1400 then proceeds to step 1404, which displays a status screen to the user as shown in journal screen 1300. This screen allows a user to type the user status in the “share what's new . . . ” field 1322. Optionally, the user may add a mood via selection of mood button 1318, which executes step 1425 of process 1400. Next, at Step 1426, various mood icons and/or emojis are displayed to the user. At step 1428, if the user selects a mood, process 1400 proceeds to step 1430, at which the mood is inserted into the field 1322. Otherwise, process 1400 continues to display the mood icons and/or emojis to the user. Once the user has finished entering a status, a user may select share via button 1320, after which process 1400 executes step 1422 and then proceeds to step 1424, at which the status is published. In the depicted embodiment, the status is published to other users of the systems and methods of the present invention. However, alternate embodiments are envisioned and which the status is shared to social media or the like. Next, process 1400 proceeds to step 1432, at which the status data is saved to a database such as information database 2420.

Alternatively, if the user selects the Photos button 1304, Step 1406 is executed, and process 1400 proceeds to step 1408, at which existing photos are displayed to the user, if any photos were previously uploaded. Photos may include any type of photo including, but not limited to, photos of the property, photos of items associated with the property, and photos to assist with maintenance of the property. The photos screen allows the user to upload new photos or delete existing photos. Upon completion, a user may select save to execute step 1431 of process 1400, which saves the photos to a database such as information database 2420.

In some embodiments, information contained in the uploaded photo may be automatically retrieved and saved to the profile for future use. For example, information about items and appliances (e.g., such as brand name, machine type, serial numbers or model numbers) may be automatically extracted from an uploaded photo. However, the invention is not so limited. Any type of information visible in the photo may be extracted from the photo. The system may use the extracted information to automatically link appliances or other items on the property to uploaded files, for example, user manuals or service manuals or to automatically obtain related information via the Internet via a search engine or the like.

If the user selects the Videos button 1306, Step 1410 is executed, and process 1400 proceeds to step 1412, at which links to videos are displayed to the user, if any videos were previously uploaded. Videos may include any type of video including, but not limited to, video of the property, video of items associated with the property, security camera video, and video to assist with maintenance of the property. The video screen allows the user to upload new video or delete existing video. Upon completion, a user may select save to execute step 1431 of process 1400, which saves the video to a database such as information database 2420.

If the user selects the files button 1308, Step 1414 is executed, and process 1400 proceeds to step 1416, at which file names are displayed to the user, if any files were previously uploaded. Files may include any type of file including, but not limited to, user manuals for various appliances installed on the property, a contractor invoice, a seller disclosure, a service manual, a receipt, a survey, an inspection receipt, and the like. Upon completion, a user may select save to execute step 1431 of process 1400, which saves the files to a database such as information database 2420.

If the user selects the link button 1310, Step 1418 is executed, and process 1400 proceeds to step 1420, at which link names are displayed to the user, if any links were previously uploaded. Links may include any type of link including, but not limited to, URLs to user manuals for various appliances installed on the property, URLs to third-party property valuations, URLs for a realtor website listing the property, and the like. Upon completion, a user may select save to execute step 1431 of process 1400, which saves the links to a database such as information database 2420.

In the depicted embodiment, it is possible also for the user to download any of the various media associated with the profile and/or property. From the respective screen, a user may simply select a download button, which will execute step 1434 of process 1400. Process 1400 then proceeds to step 1436, at which the desired media is retrieved from the corresponding database. Next, at step 1438, the media is made available to the user in a form that allows it to be downloaded.

Furthermore, in the depicted embodiment, the user may upload media (e.g., photos, videos, files, links, and the like) to the journal from a mobile device. In another embodiment, the media may be received through crowdsourcing via an external API or through internal survey/data collection capabilities. Or, some or all of the media stored in the journal section may be input to the system automatically by a third party with proper access privileges, such as a stakeholder, insurance carrier, or the like.

The media contained in the journal may be of any type including, but not limited to, neighborhood media, media regarding a family living on the property, or any other subject matter so desired.

Referring now to FIG. 3, depicted is a flow chart of a process for calculating a property fitness index according to an exemplary embodiment of the present invention. Once a user has created a user profile and associated property profiles as discussed in greater detail herein, a property fitness index or score may be calculated and displayed to the user.

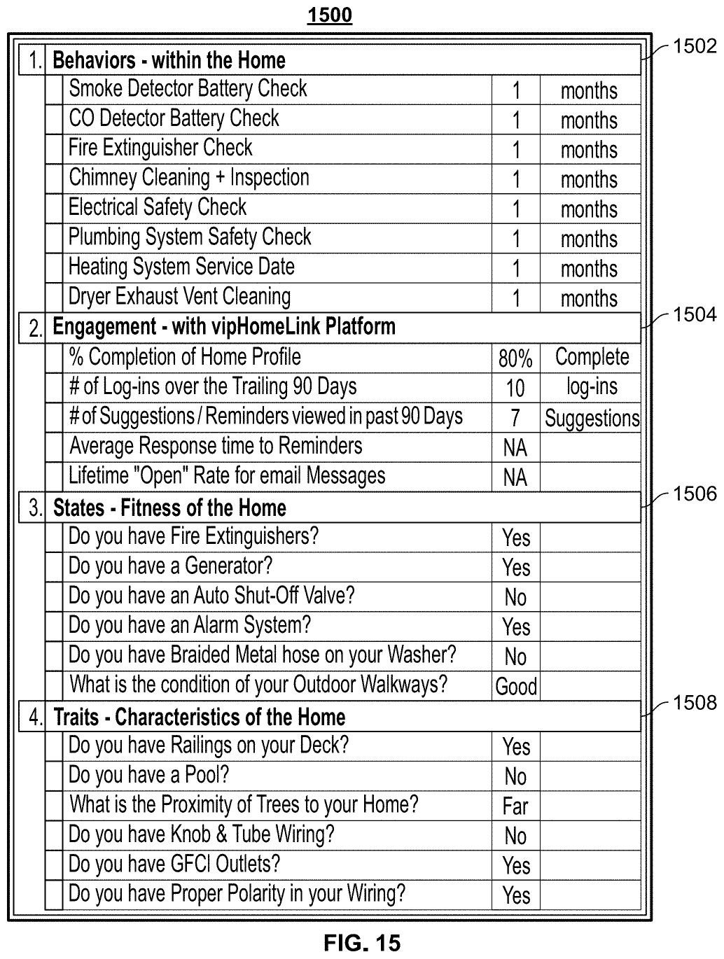

In the exemplary method of calculating a property fitness index shown in FIG. 3, process 300 begins at Step 302, at which process 300 reads the values of the traits of the property. In some embodiments, a property's traits are its inherent elements that cannot be changed in the short term. Traits can include, but are not limited to, the type of property, the number of floors or bedrooms, the structure of the property, the materials of the property, proximity of the property to water, proximity of the property to fire hydrants, proximity of the property to fire or police departments, type of basement drainage, the presence of a pool on the property, the proximity of trees to the structure, the type of wiring (e.g., knob and tube), the type of outlets (e.g., GFCI), and proper polarity in the wiring. An exemplary list of traits in accordance with an embodiment of the invention are shown in the traits section 1508 of chart 1500 in FIG. 15. In alternate embodiments, traits may be eliminated, added, and/or substituted without departing from the scope hereof. In the exemplary embodiment, each trait has a value of one, however, varying values may be substituted without departing from the scope hereof. Further, although all traits have the same value in the depicted embodiment, alternate embodiments are envisioned in which different traits have different values.

Next, process 300 proceeds to Step 304, at which the value of each trait (as read in step 302) is multiplied by a weight. This weight may be based on any criteria such as, but not limited to, importance to safety and/or value of the home relative to other traits or other criteria of the property index. In alternate embodiments, weights can be based on feedback from the user, a partner, a system administrator, a stakeholder, an artificial intelligence algorithm, third party with access to the system, or any combination thereof. For example, if an insurance company has a high number of claims related to tree damage, the feedback might provide a higher weight for trees that are farther from the structure. Feedback can be entered manually by logging into the system or automatically through the use of an API or other method of interfacing with the system, including, but not limited to, a smart speaker. Any one or more of the values discussed in process 300 (i.e., user behavior values, user level of engagement values, property states values, and property traits values, and the property fitness score) can be weighted based on feedback.

Next, at Step 306, process 300 reads the values of the user engagements. In some embodiments, user engagement relates to the user's engagement with the system. User engagements may include, but are not limited to, the percent completion of system or profile tasks by the user of the property profile, the number of times the user has logged into the system within a certain time period, the number of times the user has viewed reminders or suggestions presented by the system within a certain time period, the average time it takes the user to respond to reminders, the number of recommendations the user has completed, the number of activities in the user's account, and the rate at which the user opens email messages regarding the property.

An exemplary list of user engagements in accordance with an embodiment of the invention are shown in the engagement section 1504 of chart 1500 in FIG. 15. In alternate embodiments, user engagements may be eliminated, added, and/or substituted without departing from the scope hereof. In the exemplary embodiment, each user engagement has a value of one, however, varying values may be substituted without departing from the scope hereof. Further, although all user engagements have the same value in the depicted embodiment, alternate embodiments are envisioned in which different user engagements have different values.

Next, process 300 proceeds to Step 308, at which the value of each user engagement (as read in step 306) is multiplied by a weight. This weight may be based on any criteria such as, but not limited to, importance to safety and/or value of the property relative to other user engagements or other criteria of the property index.

Next, at Step 310, process 300 reads the values of the user's behaviors. In some embodiments, user behaviors relate to the user's behavior relative to the property. User behaviors may include, but are not limited to, the number of property activities completed, the timing of the completed property activities, and the type of property activities completed. Activities are actions that the user takes in order to properly maintain and/or upgrade the property including, but not limited to, checking smoke detector batteries, checking carbon monoxide detector batteries, checking fire extinguishers, performing an electrical safety check, performing a plumbing safety check, having the heating system serviced, cleaning a dryer exhaust vent, and the like.

An exemplary list of user behaviors in accordance with an embodiment of the invention are shown in the behaviors section 1502 of chart 1500 in FIG. 15. In alternate embodiments, user behaviors may be eliminated, added, and/or substituted without departing from the scope hereof. In the exemplary embodiment, each user behavior has a value of one, however, varying values may be substituted without departing from the scope hereof. Further, although all user behaviors have the same value in the depicted embodiment, alternate embodiments are envisioned in which different user behaviors have different values.

Next, process 300 proceeds to Step 312, at which the value of each user behavior (as read in step 310) is multiplied by a weight. This weight may be based on any criteria such as, but not limited to, importance to safety and/or value of the property relative to other user behaviors or other criteria of the property index.

Next, at Step 314, process 300 reads the values of the property states. In some embodiments, a property's states relate to its current conditions that cannot be changed in the short term. States can include, but are not limited to: the existence of smoke detectors, fire extinguishers, auto shut-off valves, an alarm system, and a generator; the condition of an outdoor walkway; and the presence of braided metal hose on the washer. An exemplary list of properties states in accordance with an embodiment of the invention are shown in the states section 1506 of chart 1500 in FIG. 15. In alternate embodiments, properties states may be eliminated, added, and/or substituted without departing from the scope hereof. In the exemplary embodiment, each property state has a value of one, however, varying values may be substituted without departing from the scope hereof. Further, although all property states have the same value in the depicted embodiment, alternate embodiments are envisioned in which different properties states have different values.

Next, process 300 proceeds to Step 316, at which the value of each property state (as read in step 312) is multiplied by a weight. This weight may be based on any criteria such as, but not limited to, importance to safety and/or value of the property relative to other properties states or other criteria of the property index.

Next, at Step 318, the system sums all of the weighted values from steps 302-316 to obtain a property fitness index or score (or in the case of a home, this may be called a “Home Fitness Index”). In some embodiments, the property fitness index is called a “B.E.S.T. Metric” (an acronym for: Behavior. Engagement. States. Traits). The property fitness index is then presented to the user.

The property fitness index can be the sum of all the weighted values, or it can be based on a more complex model, including sub-models, internal meta-models, or other algorithms. The combination can be determined from an internal algorithm or an externally-defined algorithm (for example, by a stakeholder). It can be based on dynamic weightings (depending on region or property types) or can be based on autonomic weightings (defined by changes). The index may automatically change based on home history or home type. For example, a user will only receive up or down points for cleaning a dryer vent if the property is equipped with a dryer. If the property does not have a certain item, then the scoring element for that item is removed when calculating the score. For example, if there is no dryer on the property, then cleaning a dryer vent will not be included in the calculation. In this way, scoring is tailored to a specific property.

The property fitness index or score can alternatively be based on incomplete data through the use of heuristics or incomplete scoring. The property fitness index or score can be presented to the user visually, for example, via graphs, charts and other figures, or audibly through a smart speaker, such as the Amazon Echo®, the Apple HomePod™ or the Google Home™.

The system repeats steps 302-318 to update the property fitness index or score periodically. The update can be initiated automatically based on a schedule, based on certain triggers (a user navigating to the dashboard), or may be initiated manually by the user, another stakeholder or a partner.

It should be noted that the property fitness index or score will continually change based upon the user's behavior relative to the property, the user's engagement with the system, and any changes to the states or traits of the property. All of these factors will be continually monitored by the systems and methods of the present invention to ensure that the property fitness score is always up-to-date.

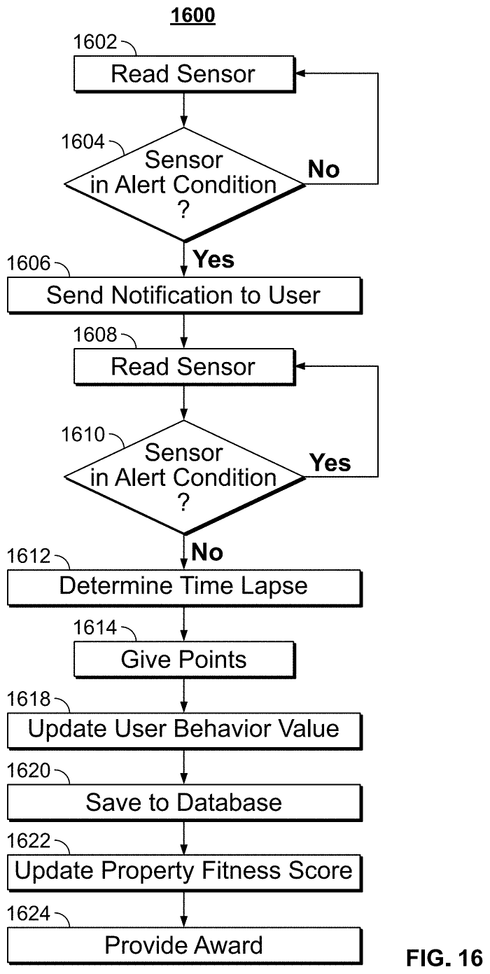

Referring now to FIG. 16, depicted is an exemplary flow chart depicting the steps to track items in a property via a sensor, track and reward user behavior, and incorporate same into a property fitness index in accordance with one exemplary embodiment of the present invention. Process 1600 begins at Step 1602, at which the value of a sensor that has been placed within the property is read. For example, the battery level of a smoke detector may be tracked by the system in order for the system to know when to notify the user that the battery needs to be replaced. The system may also be notified when the smoke detector is signalling that it senses smoke. Other sensors can monitor statuses such as, but not limited to, door states (open/shut), water filter status, air filter status, water levels, and other conditions on the property. In addition, some alerts they be scheduled by the user, such as seasonal or periodic alerts. An example of a periodic alert is to replace an air filter every 4 months or to check the smoke detector batteries every 6 months. The system allows the user to define one or more parameters for an alert, including methodology, notification type, alert type, notification frequency, alert frequency, or combinations thereof. For purposes of illustration, the sensor read in the embodiment depicted in FIG. 16 is an airflow or pressure sensor that determines the condition of a filter in an HVAC system. However, in alternate embodiments, other sensors may be read. In some embodiments, multiple sensors are read, and each sensor can individually trigger an alert that requires the user's intervention.

In Step 1604, process 1600 determines whether the sensor is in alert condition. In this example, if the airflow across an HVAC filter does not read below a predetermined limit, it is not dirty and it not in need of replacement. In such case, process 1600 returns to Step 1602, at which it continues to read/monitor the status of the sensor. Alternatively, if the airflow across the HVAC filter is below a predetermined limit, process 1600 determines that the filter is dirty and needs to be replaced, i.e., the sensor is in alert condition. Process 1600 then proceeds to Step 1606, at which a notification is sent to the user to notify him or her of the alert condition and the need to replace the filter. In situations in which multiple filters are present in a property (e.g., first and second floor filters), additional information will be provided to indicate the specific filter in need of replacement. The system notification may include, but is not limited to, notifications via printing, email, push alerts, and other electronic means.

Next, at Step 1608, process 1600 again reads the sensor. Then, at Step 1610, process 1600 determines whether the sensor is still in alert condition. If yes, the user has not yet changed the filter and process 1600 returns to 1608 and continues to read the sensor status until it determines that, at 1610, the sensor is no longer in alert condition. At such point, process 1600 proceeds to Step 1612.

At Step 1612, process 1600 determines how much time elapsed between notification of the alert condition and remediation of the alert condition (i.e., in this example, the amount of time it took the user to change the filter). Next, at 1614, the elapsed time is compared to predetermined performance metrics to ascertain the timeliness of the remediation. If remediation is timely, points may be given to the user and or added to the property fitness index summation or other calculation. That is, in an embodiment, the faster the user addresses an issue, the more points he or she receives. In the depicted embodiment, remediation response time is a dedicated user behavior, and the value of this user behavior is updated according to response time at Step 1618. However, alternate embodiments are envisioned in which the weighting of this variable is changed in lieu of or in addition to the value of the user behavior variable. In other embodiments, these points are merely added to the summation that calculates the property fitness index, an example of which is described relative to Step 318 (FIG. 3). Alternate embodiments for factoring remediation response time into the property fitness score may be substituted without departing from the scope hereof. Process 1600 then proceeds to 1620, at which the user points and/or calculated values are saved to a database.

Process 1600 then proceeds to 1622, at which the property fitness index is updated based upon the new information. This may be done by executing an algorithm such as process 300 as shown in FIG. 3.

Finally, process 1600 proceeds to 1624, at which it determines whether an award should be provided to the user. That is, the systems and methods of the present invention may incorporate gamification to encourage the user to be involved in the monitoring and maintenance of the property. The user may be awarded points, badges, tiles, or other awards for engaging in upgrade and/or maintenance of the property. The system may allow users to compete among themselves. In an embodiment, the system maintains a leaderboard of all users in the system and provides prizes to users such as the most engaged users or those that maintain the highest property scores over a certain length of time. Such awards may be published to other users or third parties in the same manner that the systems and methods of the present invention publish status as discussed herein with respect to Step 1424 (FIG. 14). For example, in one such embodiment, the user is provided awards for reading a predetermined quantity of available suggestions, maintenance information or upgrade information, as provided by the systems and methods of the present invention. However, other user activities may also be rewarded with awards without departing from the scope hereof.

In addition to those features described above, additional features are also envisioned. For example, embodiments of the invention are envisioned and which it is possible for a first user to copy or transfer all or a portion of the information in his or her profile to the profile of a second user. It is also possible for the first user to generate a profile report and share the report with a second user or anyone else, including a stakeholder or other third party that may or may not have a system profile. In an embodiment, the copy, transfer, or share of information is initiated by the first user via entering an email address or other information associated with the second user such as, but not limited to, a phone number, social media account, or the like. In such embodiments, it is also envisioned that a user is able to designate portions of his or her profile information as permanent or temporary. In such an embodiment, information designated as temporary will not be copied, transferred or shared along with the other information in the profile. In some such embodiments, information designated as temporary may optionally be purged.

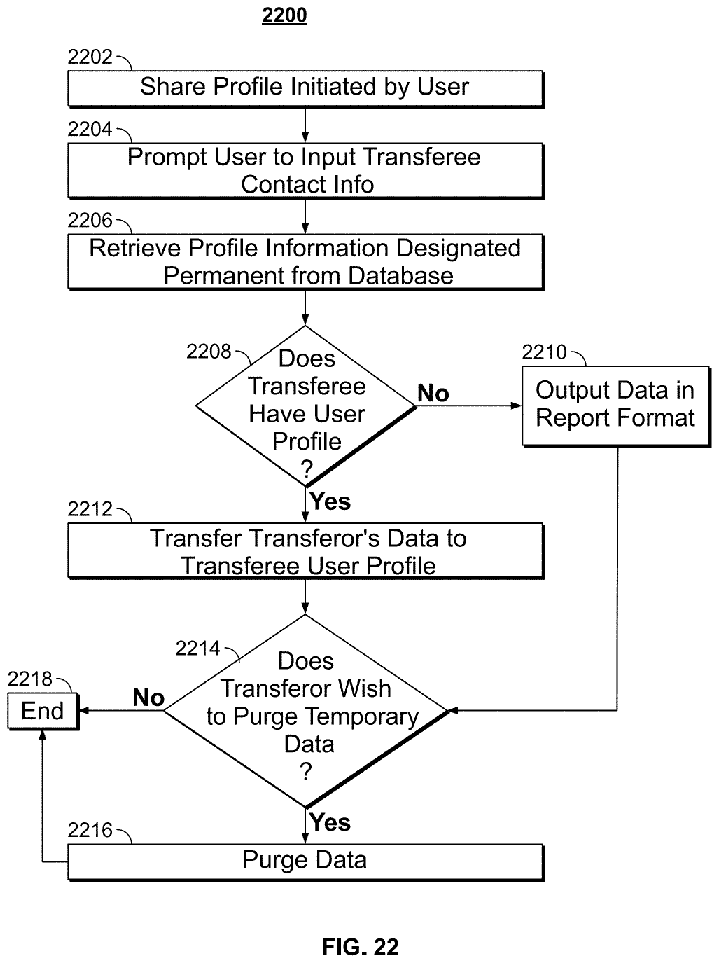

FIG. 22 depicts a flow chart depicting a profile sharing process 2200 in accordance with one embodiment of the present invention. At Step 2202, a user initiates the sharing of his or her profile by, for example, clicking a “share profile” button or the like. Next, at Step 2204, process 2200 prompts the user to input the contact information for the profile transferee. This information may include, but is not limited to, email address and username. Process 2200 then proceeds to Step 2206, at which the profile information to be transferred is retrieved from a database. In some embodiments, portions of profile information may be designated as permanent or temporary. In such embodiments, the information retrieved at Step 2206 is only that information designated as permanent. However, embodiments of the present invention are envisioned in which all profile information is permanent and/or is retrieved during Step 2206.

Process 2200 then proceeds to Step 2208 at which it queries, for example, a database to determine whether the profile transferee has a system profile. If no, process 2200 proceeds to Step 2210, at which the profile information to be transferred is output in a report format such as, but not limited to, a PDF report, a word report, a graphical report, and a PowerPoint presentation. Otherwise, if, at Step 2208, the profile transferee has a system profile, process 2200 proceeds to Step 2212. At Step 2212, process 2200 transfers the profile information to the user account associated with the transferee and/or the transferee's username.

Next, at Step 2214, process 2200 queries whether the profile transferor wishes to purge profile data designated as temporary. If yes, process 2200 proceeds to Step 2216, at which all profile data designated as temporary data is purged from the corresponding database. Thereafter, process 2200 proceeds to Step 2218, at which it ends. If the user does not wish to purge temporary data at step 2214, process 2200 proceeds directly to Step 2218, at which it ends.

In further alternate embodiments, the user can create subaccounts that have access to the information in the profile. In an embodiment, a subaccount has access to all information in the profile. In an alternate embodiment, a subaccount only has access to a portion of the information in the profile. The user can manage the amount of access available to each subaccount. For example, a user may allow an electrical contractor to access electrical information, fields, and/or data only.

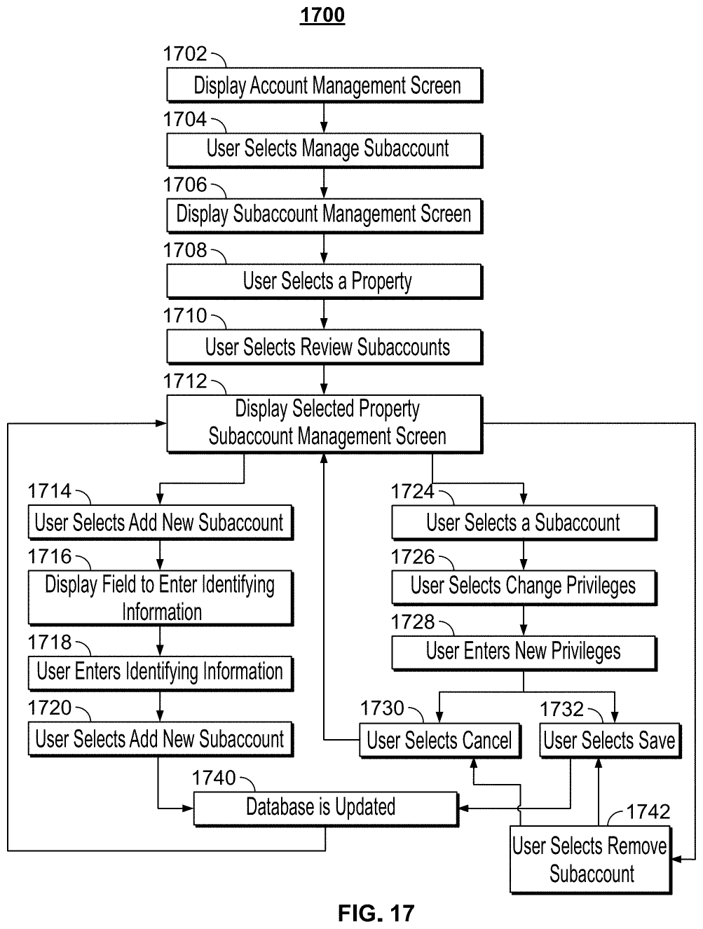

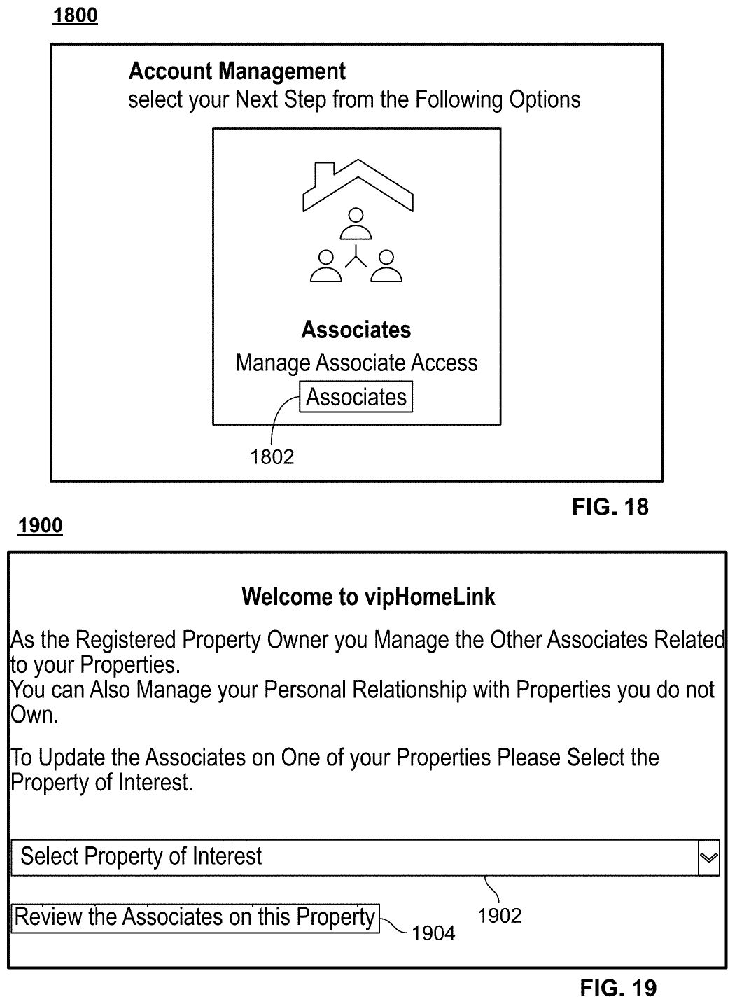

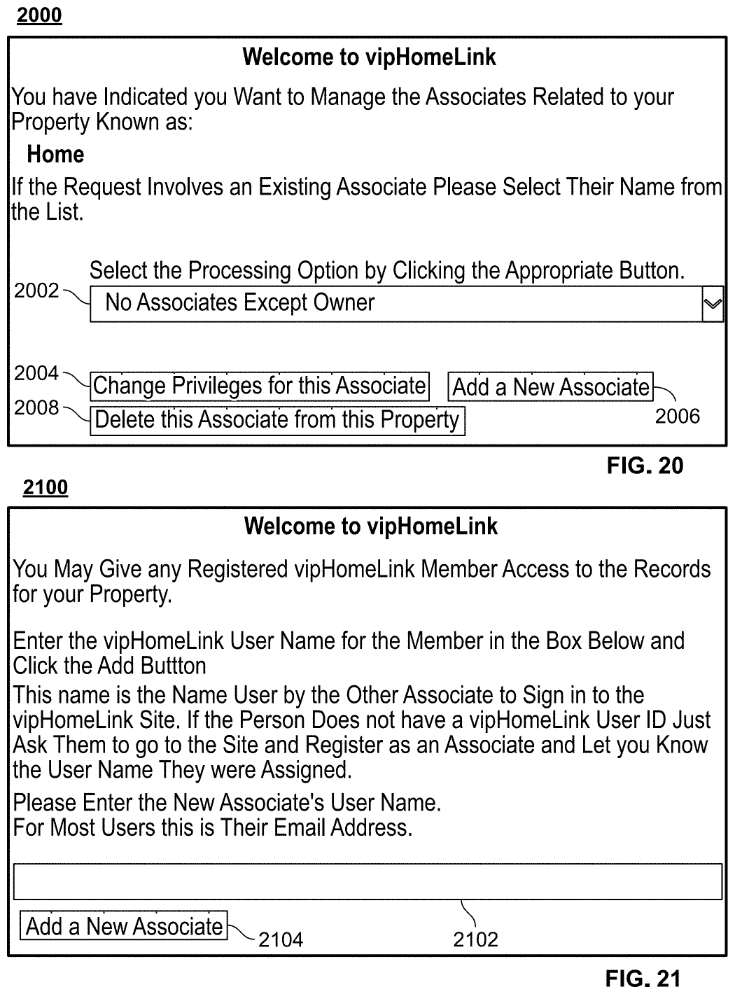

Referring now to FIGS. 17-21, depicted is an exemplary flow chart depicting process 1700 for allowing user to create and manage a user sub-account. Management of a user sub-account may include modifying privileges for the sub-account. The system may refer to the user sub-account privileges to determine the areas of the profile to which each sub-account user has access. To access sub-account options, the user starts process 1700 at Step 1702, at which the account management screen 1800 is displayed to the user. When the user selects “Manage Subaccounts” at Step 1704 by selecting button 1802, process 1700 proceeds to Step 1706, at which process 1700 displays a sub-account management screen 1900.

Next, at Step 1708, the user selects a property from the list 1902 for which to manage the sub-accounts. After selecting the desired property, process 1700 proceeds to Step 1710, at which the user may review any existing sub-accounts for the selected property by selecting button 1904. Next, process 1700 proceeds to Step 1712, at which a property sub-account management screen 2000 is displayed to the user.

From property sub-account management screen 2000, the user can choose to add a new sub-account at Step 1714 by selecting button 2006. Or, a user can select an existing subaccount from list 2002 at Step 1724 to either modify the selected subaccount's privileges or remove the subaccount's privileges for the property. If the user selects button 2006 to add a new subaccount, process 1700 proceeds to Step 1716, at which field 2102 of screen 2100 is displayed to the user to allow the user to enter information to identify the new sub-user who will be associated with the sub-account. For example, this information may include an email address. The user then enters the identifying information into field 2102 at Step 1718 and then selects button 2104 to add the new sub-account, thereby executing Step 1720. Next, the new account information is saved to a database such as user database 2410 at Step 1740. In an embodiment, a different database is used to store this information. After the database is updated, process 1700 returns to Step 1712, at which a user can again choose to add a new sub-account or view or modify privileges for an existing sub-account.

Also, from the property sub-account management screen 2000 displayed via execution of Step 1712, the user can choose which areas of the profile that the sub-account can access by clicking button 2004. The user selects a subaccount and then selects button 2004 to change the subaccount user's privileges at Step 1726. The user then enters new privileges for the sub-account user at Step 1728. Next, a user may cancel the changes (at Step 1730) or save the changes (at Step 1732). If the user chooses to discard changes at step 1730, process 1700 proceeds directly back to 1712. If the user chooses to save the changes, process 1700 proceeds to 1740, at which the user database is updated. After the database is updated, process 1700 proceeds back to Step 1712, at which a user can add a new sub-account or modify privileges for an existing sub-account.

Further, from subaccount management screen 2000, a user may remove a sub-user's access to a property. This may be performed by selecting button 2008, thereby executing Step 1742. Next, a user may cancel the changes (at Step 1730) or save the changes (at Step 1732). If the user chooses to discard changes, process 1700 proceeds directly back to 1712. If the user chooses to save the changes, process 1700 proceeds to 1740, at which the user database is updated. After the database is updated, process 1700 proceeds back to Step 1712, at which a user once again has the option to add a new sub-account, select privileges for an existing subaccount, or remove a subaccount.

In an alternate embodiment, the Dashboard 200 can also display various costs to the user, such as the cost of maintaining the property and the cost of future upgrades to the property. The system may calculate the cost based on information in the profile, including information uploaded into the journal, and from outside sources. These outside sources can contain such information as tax rates and general surveys of property ownership in the area. The system can also calculate budgets for maintenance and upgrades and present them on the Dashboard 200 or on any other appropriate screen.

In an embodiment, the first step in calculating the cost of maintaining or upgrading the property is to read information about items to determine if they require any maintenance or upgrade. This can be done automatically through, for example, sensor input, or information that has been input manually. The next step is to look up the cost of maintenance or upgrade of these items in a database. This database can be internal (e.g., based on information input by the user, a stakeholder, or a partner) or external. Then, the maintenance or upgrade costs may be summed to determine the total cost of performing all maintenance or upgrades associated with the property.

Alternate embodiments are also envisioned in which the system has the capability to determine if the property has proper insurance coverage. This determination is based on the value of the property and items on the property as calculated from information in the profile, such as replacement costs for items and states and traits of the property. The system may include a mapping table, which compares the current insurance information and/or the property's current insurance coverage levels (as may be input to the profile by an insurance carrier) to maintenance and replacement costs to analyze alignment or disparity between the coverage and the replacement costs. This information can be displayed on the Dashboard 200 or on any other appropriate screen. Upon request or automatically, the system may flag deficiencies in coverage and alert the user.

The system can also assess the safety of the property based on the B.E.S.T. score and information uploaded to the system by the user, stakeholder, or other third party. For example, a safety rating is increased due to the presence of safety features on the property such as, but not limited to, a generator, an automatic water shutoff valve, and adequate smoke and fire detection items. It is envisioned that alternate models can be used to assess safety of the property, such as a Child/TODDLER Safety Index, an Efficiency Index, or other models. In an embodiment, a safety assessment may be requested by the user, a stakeholder, or a partner, or may be provided based on a predetermined schedule. This safety report can be displayed on the Dashboard 200 or on any other appropriate page as an index, score, or chart, or combinations thereof.

The system can present various other information to the user, including analytics, state reports, trait reports, and risk reports. These reports can be based on calculated sub-models, internal meta-models other algorithms or combinations thereof. Partners and stakeholders may be able to access this information and certain databases and datasets through an API. In an embodiment, the algorithms compare variables of the property against external models. In an embodiment, state reports can include a listing of all the known states of the property, their current condition, their optimal value, and/or when action needs to be taken. For example, the states of smoke detectors can be listed along with battery life remaining and when the batteries should be replaced. In an embodiment, trait reports can include a listing of all the known traits of the property, their current values, recommendations for improvement, or how these traits affect the property fitness score or insurance rates. For example, the trait of wiring in the house can be listed along with the type of wiring, better wiring options, and how a better option may lower insurance rates.

In an embodiment, the various algorithms described herein can evaluate the answers to questions received via survey or the like along with the following non-exhaustive list of types of data: investment aspect; current home indices; category of home owner; internal influences on potential behavior; external influences on behavior; interest; Home Centrality Index (current home); Home SAFETY/FITNESS Index; awareness; conditions; pro-active measures; re-active measures; home traits; homes states; home resiliency index (readiness index); home gravity index; fit index; neighborhood index; home knowledge; organizational index; completion of best practices; perception; outward looking; aspirational index; projected number of projects in the future; common index; happiness in home; fit of home; wish list for home; completeness of projects; issues index; convenience index; location index desirability index; contentment index; home-centric profile; property information; appearance of property; property overview; physical description; structural aspects of the home; solar electrical systems; safety systems; utilities; contractors; home service plans; insurance; beta/bullpen options; adv/appliances; adv/inspection report; control panel information; control panel model; control panel in-service date; control panel menu; and attachment zone map.

In an embodiment, a risk report is a poly-faceted amalgamation of results which include, but are not limited to reminders (time-sensitive alerts about behaviors or changes to the home), recommendations (non-time-sensitive improvements such as automatic water shut-offs or central alarm systems), kudos (which highlights the positive qualities of the home or of the user's behaviors), and indices (which include the fitness index or other home or home-owner indices). One or more of these results may be generated if a threshold is exceeded.

In an embodiment, feedback is stored in language strings with unique identifiers. In an embodiment, feedback may be requested by the user, a stakeholder, or a partner, or may be provided based on a predetermined schedule. In an embodiment, the system can tailor reminders and recommendations, kudos, and/or alerts based on the property's geographical profile or zip code, which may be entered in the property profile. For example, properties in Florida will not receive reminders about checking for ice dams, and properties in New York will not receive alerts about palm tree maintenance.

This information can be tailored to the user or the partner. This information can be displayed visually on Dashboard 200 and can include survey-based feedback to the user, agents, members, stakeholders, associates, partners, public, or combinations thereof. The output information can also include one or more indices including a Home Signature Index, Home Safety/Fitness Index, Home Resiliency Index, TIPS Index, Home Health Index, or Home Centrality Index. The Home Safety! Fitness Index measures how safe the property is based on internal risk. It can be based on materials, prevention, maintenance, build and awareness. The Home Resilience Index measures how prepared the property is for external threats, including resiliency and preparedness. For example, are the emergency plans in place or are there emergency documents available? The Home Health index measures the health of the home based on internal risks, including resiliency and preparedness. For example, are the emergency plans in place or are there emergency documents available? The Home Centrality Index measures how important the property is to the user. For example, is the property the center of the user's life? Is it a part of the user's identity?

In an embodiment, models, algorithm changes, and thresholds can be amended or replaced by administrators. One way is via a graphical interface. Another is through use of an API. These updates can be imported to the system via .csv files or other supported format.

In an embodiment, the system can create a credit assessment of the user. This credit assessment can relate to insurance credits associated with the property, which are compared to those available to the property owner based on the associated insurance category. All of the above calculations and information can be compared, indexed, or benchmarked against other elements in the system based on region, town, state, property type, risk profile, other meta-index, or combinations thereof.

Alternate embodiments are envisioned in which a partner accesses the system to obtain actionable insights into property ownership. In an embodiment, an insurance carrier has access to its own dynamic dashboard for management or actuaries. From there, the carrier has access to its own analytics and mitigation processes to benefit the carrier and its policyholders. The system gives the carrier such anonymized metadata and proprietary indices as aggregate home-owner behaviors, engagement metrics, compliance measures, and regional insights.

In an embodiment, the system utilizes artificial intelligence and may include the use of evidence-based predictive analytics (for example, predicting when an item can or will fail), diagnostics and root cause analysis (for example, determining that hot water heaters last 60% as long in homes without a water softener), and cross-reference analytics and/or prediction (for example, cost of the home's predicted preventative maintenance), or a combination thereof. In an embodiment, a database stores functional expectancy thresholds and evidence-based thresholds. The user will receive reminders and recommendations based on these thresholds. For example, a user with a certain brand and model of hot water heater will receive the appropriate message notifying her that she should consider replacement based on the threshold data.

Alerts

In an embodiment, the system can present alerts to the user. These alerts can be displayed on Dashboard 200, pushed to a mobile device, sent as a message, or presented as a notification. The alerts can be based on sensors, weather, events, seasons, recall information, or a combination thereof. Weather alerts can include severe rain or snow, hurricane conditions, flood warnings, or other extreme conditions that could cause damage to the property. Event alerts can include hot water heater failure, boiler failure, or the like. Season alerts are for changes from one season to the next to notify the user to make seasonal changes to the property, such as to replace window screens with storm in windows or to drain the water from outside pipes, so they do not burst in the winter. Recall information can be based on property profile documents, general recalls, or combinations thereof. If an item has been recalled by the manufacturer, the system can notify the user to stop using the item and to have it replaced or destroyed. Alternatively, or in addition, the system can determine items that have been recalled through documents uploaded to the profile. The system allows the user to define the alert parameters, including methodology, notification type, alert type, notification frequency, and alert frequency. In an embodiment, additional designated alerts can be sent to family, neighbors, authorities, or others who may take action to remediate the issue.

### Examples of Use

In an embodiment, a property owner enters key information into the profile including, but not limited to, key facts about the property, recent activities including maintenance, receipts, and/or media related to issues. While entering the information the property owner is presented with information based on her responses to completing the profile. Upon completion of entering the data into the profile, the property owner clicks on the reports option and is provided with a safety score and recommendations. The property owner then completes a sub-set of the recommended task and updates her profile to reflect the updates and changes. The property owner then re-runs the report to review the updated report and recommendations.

In another embodiment, a property owner needs to pull information about the roof, but she is not home to get such information from physical records. The property owner is able to quickly and easily access this information remotely and provide it to the necessary parties.

In another embodiment, an insurance company seeks to pull a report of the risk profile of a sub-set of the properties on the system (ideally pursuant to a data share agreement and affirmative user acceptance of governing terms and conditions). The insurance company, or an agent acting on its behalf, logs into an administrative section where be provides query criteria for the report. He then accepts the query parameters and initiates the analytics processes. Then the system generates and presents the report, which can be reviewed or printed for future use.

In another embodiment, a property owner is preparing to sell her property and completes a profile on the system. The property owner inputs key information about the property and about what has been done to it historically. Prior to the sale, the seller makes the information available to the buyer, so the buyer is aware of the prospective property, its improvements, and its condition. At the time of sale, the property owner provides the new owner access to the account, thereby instantly transferring a curated set of records and status of the property.

In another embodiment, A homebuilder needs to convey important information about a property to a new buyer. The homebuilder, or an agent on his behalf, is able to upload the information into the system prior to providing the access rights to the new buyer. Once the ID is transferred to the buyer, the buyer will have a full electronic record of the key elements of the house plus recommendations tailored to the house's traits.

Property/Home Value Boost

The existing valuation and value-tracking methodologies in the market, such as Comparative Market Analysis (CMA), are logically and inherently limited in accuracy due to limited and non-dynamic inputs. For example, CMA focuses on sales of pseudo-comparable properties within a defined geographic vicinity. However, the largest variables in the accurate valuation of a home are the level of maintenance and the improvements to the home. These variables are not considered by traditional CMA valuations. The systems and methods of the present invention adjust and/or enhance traditional property valuation techniques by incorporating input(s) relating to property maintenance and improvements.

An embodiment of the present invention is described herein that includes a property value boost (PVB) and/or PVB Report. The property value boost provides an indication of the incremental home value achieved by a homeowner for better maintaining and improving their home. The Property Value Boost includes a method which adjusts and adapts different elements —and their associated weighting—based on the subject property and the market. The model provides a value “boost” (or uplift) based on the overall maintenance and upkeep of the property to differentiate between a poorly maintained home, a home maintained at an average level, and a well-maintained home.

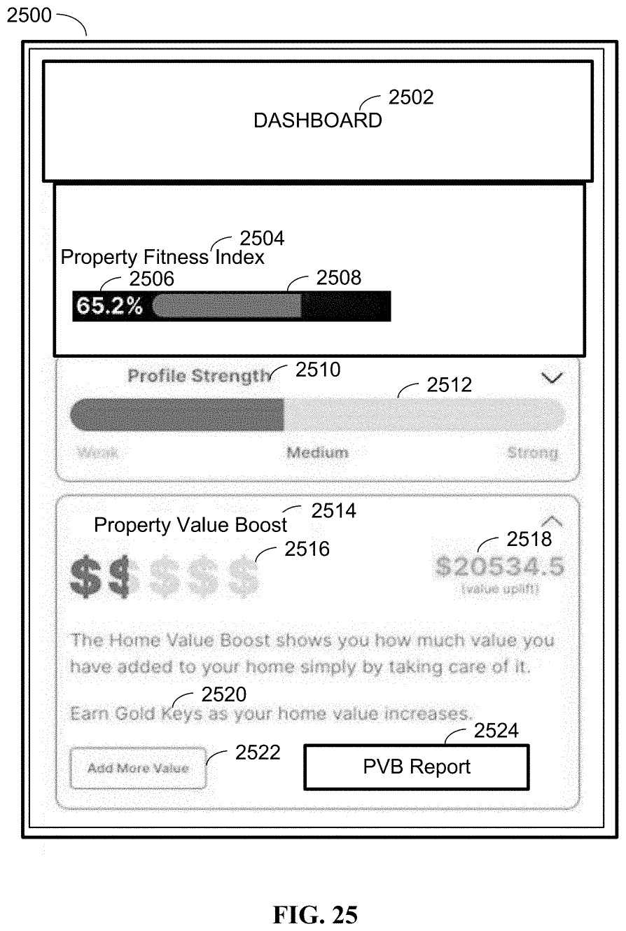

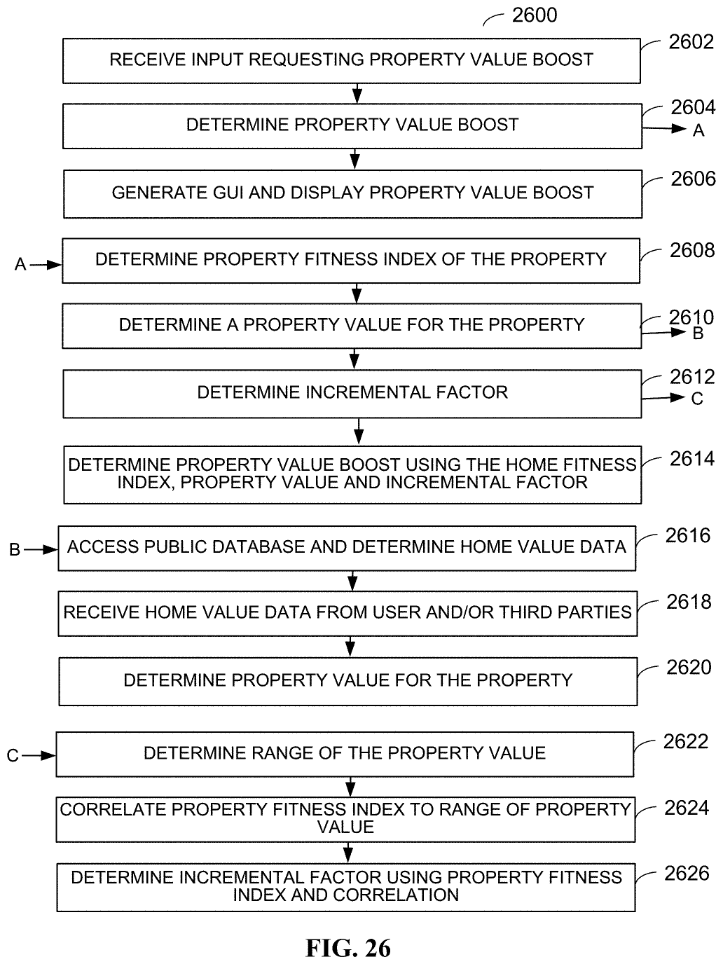

Referring now to FIG. 25 and FIG. 26, a property value boost screen 2500 and flowcharts of a process 2600 to calculate the property value boost are depicted, respectively. In FIG. 25, a screen 2500 displays a graphical user interface (GUI) generated by a system of the present invention that includes a dashboard 2502, property fitness index 2504 and one or more types of indicators 2506, 2508 of the property fitness index 2504, such as a percentage or bar graph. The process for calculating the property fitness index is described in more detail hereinabove with respect to FIG. 3.

The screen 2500 may further include a profile strength 2510 and one or more indicators 2512 of the profile strength, such as a bar graph showing a range from weak to medium to strong. The profile strength may be equivalent to or based on the completeness assessment of the profile. After the user updates the profile, the system performs a completeness assessment, in which the completed items are compared to the non-completed items to provide a completion index, which can be a percentage score, for the “required,” “optional,” or “categorical” responses. In another embodiment, the profile strength may be based on the completion index as well as one or more other factors, such as period of use of the profile, number of interactions of the user with the profile, number of recommendations completed, or other factors.

The screen 2500 also includes a property value boost 2514. The property value boost illustrates an estimated increase in the value of a property achieved by performing recommendations, suggestions, maintenance, and upgrades, e.g., as recorded in the system. The property value boost may be represented by a relative range 2516 or by a numerical value 2518, as shown in screen 2500. Alternative or additional indicators of the property value boost may be generated and displayed, such as a percentage of the property value, a range of numerical values, relative increase with respect to other properties, etc.

The system may also include an award, incentive and/or gamification relating to the property value boost 2514, such as earning “Gold Keys” 2520. For example, the system may generate and designate points or Gold Keys to a user depending on the property value boost. Additional Gold Keys or points may be provided to a user when the property value boost increases.

The GUI may also include an “add more value” icon 2522 that, when selected, initiates a process to generate recommendations to increase the property value boost. A PVB Report icon 2524 on the GUI may initiate, when selected, a process to generate a report summarizing the property value boost.

Referring now to FIG. 26, depicted are flow charts 2600 of processes for generating and determining a property value boost according to an exemplary embodiment of the present invention. When a user has created a user profile and associated property profiles as discussed in greater detail herein, a user may request a property value boost to be deter mined for one or more properties. The process receives an input, e.g., selection of an icon such as 2514, at Step 2602 requesting a property value boost for a property. The process determines the property value boost at Step 2404 (described in more detail starting at Step 2608) and generates a GUI that displays the property value boost on a screen at Step 2606.

The property value boost may be determined with respect to commercial properties, such as buildings, malls, offices, warehouses, etc. and/or with respect to residential properties, such as apartments, condos, townhouses, single detached homes, etc. In this example, the property value boost is determined with respect to a single detached home though the principles described herein may be applied to the other types of properties. In this example, to determine the property value boost of a single detached home, at Step 2608, the process retrieves a property or home fitness index from a profile of the property or calculates the home fitness index for the property, as shown and described with respect to FIG. 3 hereinabove.

At Step 2610, the process determines a property value based on one or more data inputs, such as user inputs, third party inputs or data accessed from public databases. User inputs, for example, may include, but are not limited to: the user inputting information directly into the home profile of the user; the user responding to a notification from the system that may be sent to the user via, for example, push notification, SMS text, or an alternate method; and the user recording certain information into the HomeLog or a Journal.

For example, at Step 2616, the public data may include data imports accessed using APIs to one or more publicly available databases, such as a multiple listing service (MLS) database that includes data on sales prices of properties, median property sale prices for the area, and/or comparable home sales. The process may further access a public database that includes property tax assessments and property value assessments for the area.

At Step 2618, the process may also receive user and/or third-party property value data, such as realtor appraisals or user inputs into the system relating to the estimated property value of the property. At Step 2620, the process then determines a property value using the property value data. For example, the process may calculate an average or median of one or more of: a user estimate of the property value, a realtor appraisal, one or more comparable home sale prices, median property sale prices for the areas, property tax assessment of the property value, etc. The process may weigh one or more of these data inputs in determining the property value. For example, a recent realtor appraisal of the property may be allocated a higher weight than median property sale prices for the area. Other or additional calculations and methods may be performed to determine a property value for the property.

At step 2612, the process then applies an incremental factor to the property value. The incremental factor may be an addend, multiplier, percentage, and/or other type of increment to the property value. When the incremental factor includes a percentage increase in value, then the property value boost is determined as follows:

Property Value×Incremental Factor (%)=Property Value Boost

In one or more embodiment, the incremental factor is determined using a property fitness index for the property. For example, when a property has a property fitness index at and/or above a top threshold, e.g., that reflects the top cared for and optimally improved homes in the system, then a maximum increment is applied to the property value. So, a high threshold of the property fitness index of 90% or more may result in a maximum increment (e.g., 20%).

In another example, a low threshold of the property fitness index of 50% or less may result in a minimum or no increment to the property value boost. This lower end of the range reflects the homes that are maintained at an average level, and therefore achieve the mid-point or median home value with zero property value boost. So, a low threshold of the home fitness index of 50% or less may result in a minimum increment or no increment.

Additional and/or alternative increments may be further defined for ranges of the home fitness index between the high and low thresholds. The process thus determines the property value boost using the home fitness index, property value, and incremental factor at Step 2614.

In another embodiment, the property value boost may be a negative number, e.g. the increment factor may decrease the property value. For example, when the home fitness index is at 10% or below, or unsafe conditions are detected (current fire alarm, flooding, property damage onsite), then the increment factor may generate a negative number. The negative property boost value indicates the property has a value less than the median home value for comparable homes.

One exemplary embodiment of a process to determine the incremental factor is described starting at Step 2622, wherein a range of the property value is determined. The process determines the range or variability in the property value and/or comparable home values based on one or more inputs, such as user inputs, third party inputs or public data. For example, the public data may include data imports through one or more APIs from publicly available databases, such as MLS listings. The data imports may include a range of home sale prices for the area, e.g. for comparable home sales, and/or range of property values for tax assessments. The system may also receive realtor appraisals and user inputs on the estimated range of property values.

The process then calculates a range of the property value at Step 2622. The process may determine a difference between the (median) property value and each of a plurality of comparable home prices. The plurality of differences may be used to determine a standard deviation from the property value. The range may be based on the standard deviation or other indicator of the variability of the comparable property values and the property value. For example, the property value may be $500,000 with a standard deviation or range in the property value of +/−$50,000. The range in the property value thus indicates a possible range in value for the property, e.g., relative to other comparable homes.

The process may then correlate a range or threshold of the home fitness index to the range in the property value at Step 2624. The process determines one or more thresholds or ranges of the home fitness index and the correlated range in the current home value to determine the incremental factor. For example, for a home fitness index of 90% or greater, the incremental factor may be set to the top of the range in the property value, such as $50,000 or 10%. For a home fitness index of 50% or less, the incremental factor may be set to the lowest value in the range, such as $0. In another example, for a home fitness index in the range of 51% to 60%, the incremental factor may be correlated to 2% or $10,000. For a home fitness index in the midrange of 61% to 70%, the incremental factor may be correlated to 4% or $20,000. For a home fitness index in the midrange of 71% to 80%, the incremental factor may be correlated to 6% or $30,000. For a home fitness index in the range of 81% to 90%, the incremental factor may be correlated to 8% or $40,000. In an embodiment, a home fitness index of 10% or less, may receive a negative incremental factor, such as −$40,000. The process thus correlates certain thresholds and/or ranges of the home fitness index to the range in the property value.

For a specific property, using this correlation and the home fitness index for the property, the incremental factor may be determined at Step 2626. This process is exemplary and other methods or processes may be implemented to determine the property value boost using the home fitness index, property value and/or other factors. The process for calculating the property value boost is customizable for the market, types of subject properties, and is further adaptable to changing market conditions.

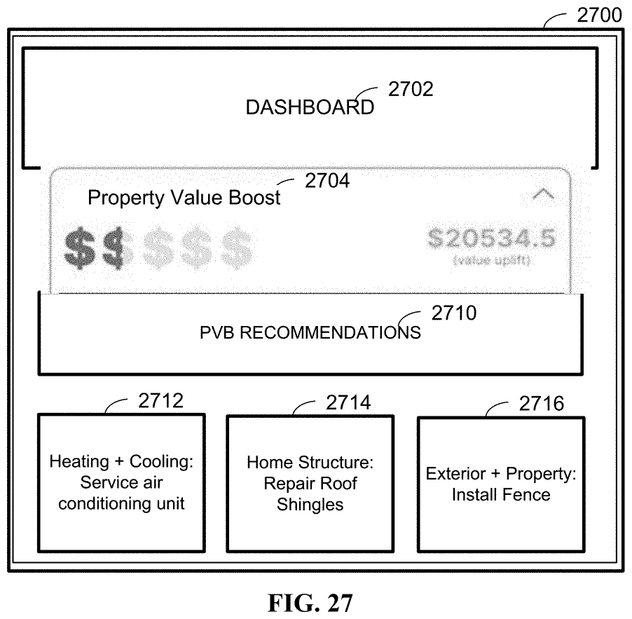

As described above, the screen 2500 in FIG. 25 includes an icon 2522 labelled “add more value”. Referring now to FIG. 27, when the “add more value” icon is selected, the system generates a GUI on a screen 2700 including a dashboard 2702 and one or more PVB recommendations 2710 to increase the property value boost 2704. The PVB recommendations 2710 may be related to one or more categories 802a-k shown in and described with respect to FIG. 8, such as maintenance and prevention, home structure, fire and chimney, electrical and power, water and plumbing, heating and cooling, health and safety, security and monitoring, appliances, exterior and property and/or insurance. The PVB recommendations may correspond to the list of recommendations 214 shown and described with respect to FIG. 2.

Alternatively, or additionally, the PVB recommendations may include only time-sensitive or safety related recommendations that need to be addressed to maintain a certain level of the home fitness index or that add more value. For example, the PVB recommendations may include a time sensitive, heating and cooling recommendation 2712 to service an air conditioning unit that is malfunctioning or a safety-related, home structure recommendation 2714 to repair roof shingles that may be causing a leak. The PVB recommendations 2710 may also include recommendations to install or upgrade features that may add value. For example, when comparable homes include fences, the PVB recommendations may include an exterior and property feature recommendation 2716 to install a fence.

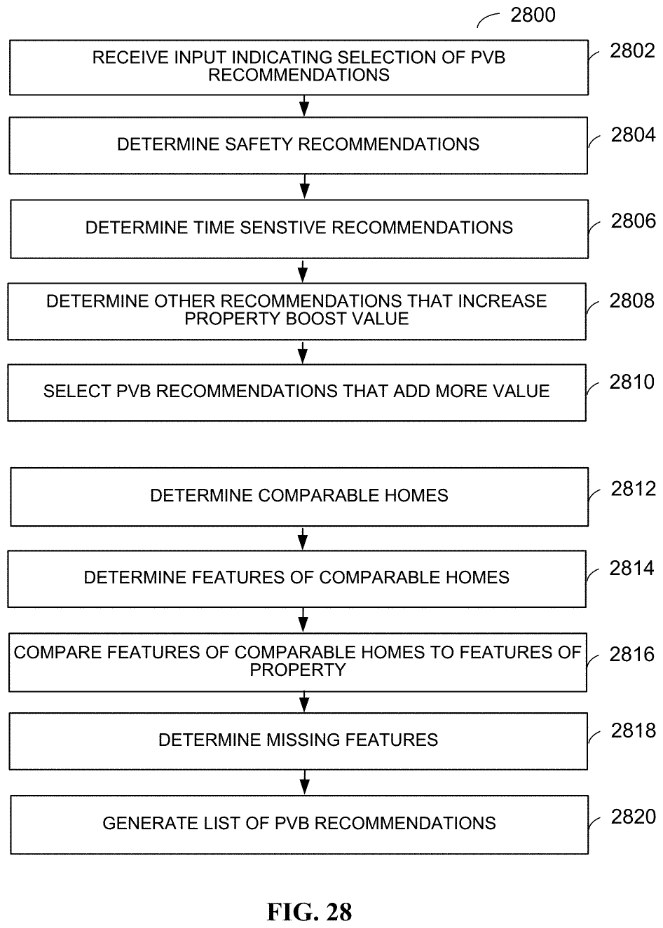

Referring to FIG. 28, a flowchart illustrates a process 2800 to determine PVB recommendations. The process 2800 receives input (such as a selection of the add more value icon 2722), to generate PVB recommendations at Step 2802. The process determines one or more recommendations associated with the property, such as the recommendations 214 described with respect to FIG. 2. In an embodiment, the process determines certain types of the recommendations, such as the safety related recommendations for the property at Step 2804, or the time sensitive recommendations for the property at Step 2806, and/or other recommendations that may increase the property value at Step 2808. The process may list each of these recommendations in the screen 2700.

In another embodiment, the process allocates a value to the recommendations and determines the recommendations that may add more value to the property. For example, the process may allocate a higher value or cost to safety or time sensitive recommendations or to recommendations that include upgrades. The process then compares the allocated values and selects the recommendations that add more value to the property as the PVB recommendations at Step 2810.

Additionally, in an embodiment, the process may determine one or more comparable homes, such as highest priced comparable homes, at Step 2812 and determine features of the comparable homes at Step 2814. The features may include traits, characteristics, upgrades, or other data about the comparable property. As described above, for example, the data may be obtained through MLS listings or other public databases. The process then compares the features, characteristics and/or traits of the property listed in its profile and determines features of the comparable homes not included in the profile of the property at Step 2816. The process may list the missing features or determine the missing features which would add the most value to the property at Step 2818. The process then generates the list of PVB recommendations at 2820. Additional or alternative methods may be employed to generate the PVB recommendations.

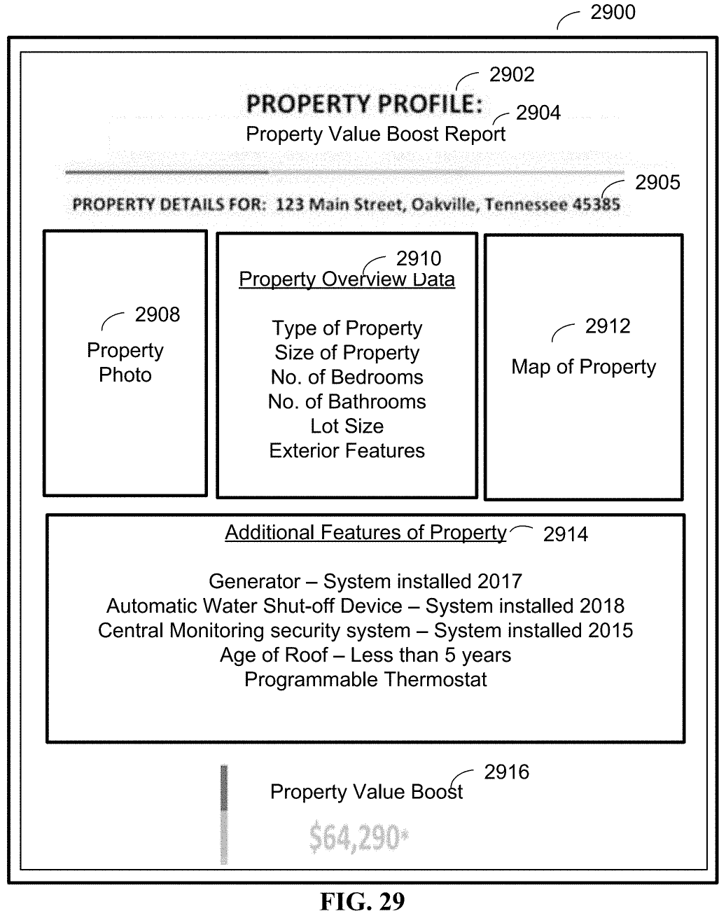

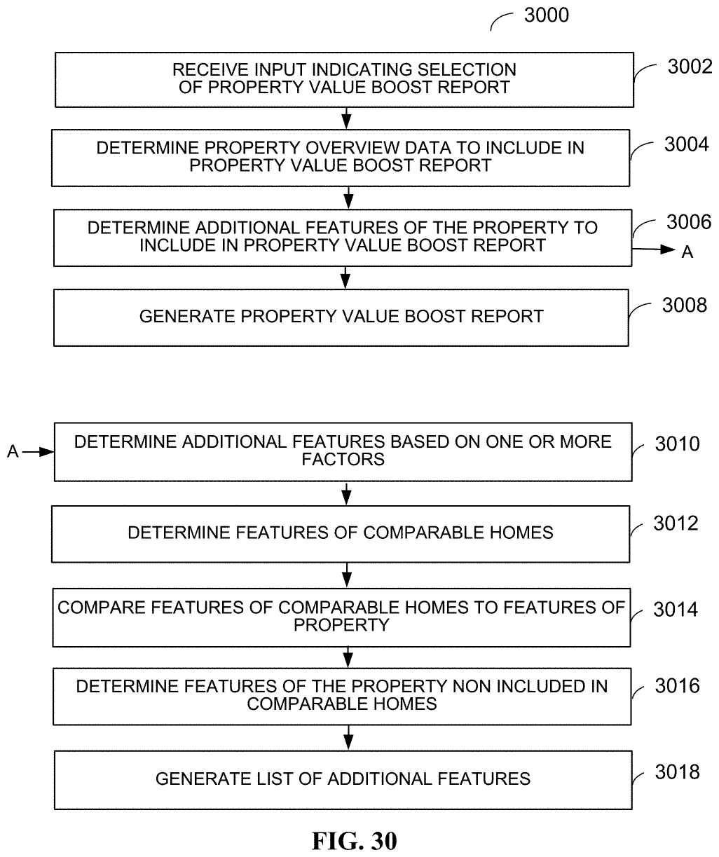

FIG. 29 and FIG. 30 illustrate a screen 2900 depicting a property value boost (PVB) summary report 2902 and a flowchart of a process 3000 to generate the PVB report, respectively. In FIG. 29, the screen 2900 displays a GUI generated by the system that includes the PVB report 2902, e.g., as part of the property profile 2904. The PVB report 2904 includes one or more of: an identification of the property 2906, a property photo 2908, and/or map of the property 2912 generated from the profile of the property.

The PVB report 2906 further includes property overview data 2910 generated from the property profile and additional features of the property 2914. The PVB report 2902 also includes the property value boost 2916. Other metrics, though not shown, that relate to the property, such as the home fitness index, profile strength, etc., may be included in the PVB report.

Referring to FIG. 30, the PVB report is generated when an input indicating a request or selection of the PVB report is received at Step 3002. In Step 3004, the process reviews the profile for the property and determines the property overview data, e.g., as shown and described with respect to FIG. 4. The property overview data in the PVB report may include approximate home size, number of bedrooms and bathrooms, year of construction or other data. Other information may be included as well such as property lot size. The process then determines additional features of the property to include in the PVB report at Step 3006. The additional features may include features, traits, characteristics, upgrades, or other data about the property. The process then generates the PVB report at 3008.

The process to determine the additional features of the property to include in the PVB report is now described. In step 3010, the additional features are selected for the PVB report based on one or more factors, such as features that increase safety, lower maintenance costs, and/or add more value. The factors may also include weight given in determining the home fitness index, as described above with respect to FIG. 3. Traits provided a higher weight when determining the home fitness index may be selected over other traits.

In an embodiment, another factor that is considered are the property features relative to comparable homes. For example, the process may determine one or more comparable homes, such as highest priced comparable homes, and the features of the comparable homes at Step 3012. As described above, for example, the data may be obtained through MLS listings or other public databases. The process then compares the features of the high valued properties and the features, traits, characteristics and other data of the property listed in its profile at Step 3014. The process then determines existing property features that comparable homes are missing or that are not included in the comparable homes, especially features that add value to the property, at Step 3016. These features may then be listed and highlighted in the PVB report at Step 3018. For example, the property may include a generator that increases safety and value, while other comparable properties do not include this feature. The PVB report thus highlights this value-add feature of the property that is not common in comparable homes.

The Property Value Boost and PVB Report may be provided to a third party, such as a realtor, mortgage company or buyer, as evidence of the incremental home value to the property due to high maintenance standards and improvements. The property value boost may thus enhance a traditional or basic CMA analysis by providing data on the overall maintenance and upkeep of the property as well as improvements to the property.

Embodiment of a Property Log

As described with respect to FIGS. 13 and 14, the system includes a journal functionality that allows a user to upload various types of media and notes on a property. For example, FIG. 13 illustrates an embodiment of a journal screen 1300 that provides a user the ability to upload a status, photos, videos, files, or links, as described with respect to FIG. 14. In an embodiment, the journal further includes a property log that tracks and reports on the history of the activities with respect to the property.

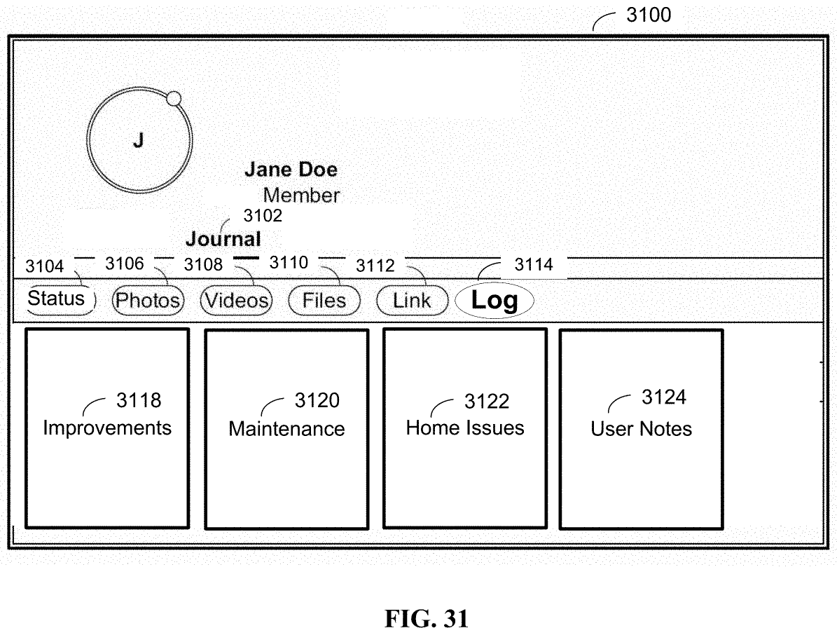

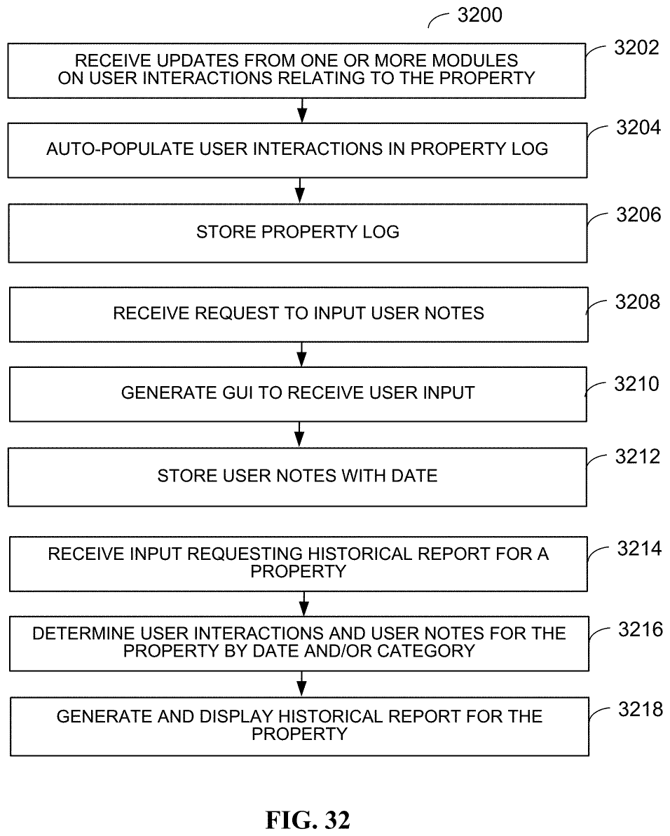

FIG. 31 and FIG. 32 illustrate a screen 3100 depicting a property log 3102 and a flowchart of a process 3200 to generate the property log 3102, respectively. In this example, the property is a home or single detached house, though in other examples, the property log 3102 may capture and report on user interactions with other types of properties.

The screen 3100 illustrates a GUI of a journal 3102 including options for status 3104, photos 3106, videos 3108, files 3110, and links 3112, as described with respect to FIG. 13 and FIG. 14. In addition, the journal 3102 includes an icon for the property log 3114. Though accessed as part of the journal GUI in this example, the property log 3102 may be incorporated or accessed through additional or alternative icons on other GUIs of the system.

The property log 3102 automatically tracks and populates lists of recorded interactions relating to the property by a user with the system. For example, the user interactions may include satisfying a maintenance reminder, executing a recommendation, completing an improvement to the property, storing additional information in the user's home profile, or other property related interaction by a user. The user interactions relating to the property are automatically captured in the property log 3102.

The property log 3102 may auto-populate one or more different categories of user interactions, such as Improvements 3104, Maintenance 3106, and Home Issue 3108. For example, the improvements category 3104 may include interactions relating to features or traits added to the property or upgrades to a current feature or trait of the property, such as pool installation or upgrading countertops. The maintenance category 3106 may list interactions relating to routine or scheduled maintenance of features or traits of the property, such as cleaning gutters or changing air filters. The Home Issue category 3108 may include interactions relating to unexpected repairs, such as repairs to a malfunctioning dishwasher or replacing a broken window.

In addition, a member-input capability enables users to directly input notes 3124 to the property log 3102. The notes 3124 may encompass a range of other activities that are not otherwise automatically captured by the system in the property log 3102. For example, such user notes may include “applied wallpaper on the master bedroom walls” or “added shelves to the hall closet”. The user inputs are separately categorized and listed in the notes 3124 of the property log 3102. A user of the system may thus track other activity relating to the property by adding notes. The user may also upload photos, upload files (such as surveys, policy information, manuals, etc), provide relevant links, etc.

Referring to FIG. 32, a flowchart of a process 3200 to generate the property log is illustrated. At Step 3202, the process includes receiving updates or status messages from one or more modules of the system. The updates include user interactions with the system relating to the property. For example, one or more software modules or system processes are configured to generate state messages to the property log module or system process upon start and/or completion of predetermined user interactions. As described above, the predetermined user interactions may include interactions relating to improvements, maintenance, and or home issues. The messages or updates from the one or more other modules include at least a property profile identification, the type of user interaction, the category of the user interaction, and date. The process auto-populates the property log for the identified property profile at Step 3204 and stores the property log with the user interaction, date, and other information at Step 3206.

The process may also receive a user request to input user notes for a property profile at Step 3208. The process then generates and displays a screen or input window or other type of GUI for entry of the notes by the user at Step 3208. The user may type or copy and paste the notes into the GUI. In addition, the process may allow an oral or voice input and provide voice to text translation. The user may also upload and associate photos, videos, files, and/or links, with the notes, as described above with respect to the journal in FIG. 13 and FIG. 14. The process stores the user notes with a date and/or timestamp to the property log at Step 3212.

A user may further request a historical report by selecting an icon or other input. In an embodiment, the user may request the historical report is organized by date and/or by category. The process receives the input requesting the historical report at Step 3214. The process accesses the property log and determines user interactions and user notes by date and/or category at Step 3216. The process then generates and displays the historical report at Step 3218. Photos or links associated with the user notes or user interactions may be included in the historical report, as well.

The historical report thus provides a history of the maintenance and improvements to a property. The historical report may be presented to a real estate agent, mortgage lender, or buyer of the property to reflect a maintenance history in support of the property value.

The aforementioned system in its preferred embodiment is for use with real-estate, more specifically, residential real estate. This system is also able to provide significant value and benefits to areas including but not limited to: all forms of real-estate, transportation, business properties, businesses, human and pet health, education, and any other uses which benefit from tracking and insight.

Although several processes have been disclosed herein as software, it may be appreciated by one of skill in the art that the same processes, functions, etc. may be performed via hardware or a combination of hardware and software. Similarly, although the present invention has been depicted as a hardwired system, these concepts may be applied to wireless systems and hybrid hardwired and wireless systems without departing from the scope of the present invention.

It will be appreciated by those skilled in the art that changes could be made to the embodiments described above without departing from the broad inventive concept thereof it is understood, therefore, that this invention is not limited to the particular embodiments disclosed, but it is intended to cover modifications within the spirit and scope of the present invention as defined by the appended claims.

I claim:

1. A system for managing maintenance of at least one property, comprising:
a computing device having a processing unit, the processing unit operatively coupled to a non-transitory computer readable medium, comprising instructions stored thereon, which, when executed by the processing unit, causes the computing device to perform the steps of:
creating or updating at least one fitness metric for the at least one property;
determining a property fitness index of the at least one property using the at least one fitness metric;
determining a property value for the property; and
determining a property value boost for the property using the property value for the property and the property fitness index for the property.

2. The system of claim 1, wherein the computing device further performs the step of:
generating a graphical user interface (GUI) for display including the property value boost for the property.

3. The system of claim 1, wherein the computing device performs the step of determining a property value for the property, by:
accessing at least one public database, wherein the at least one public database includes sale prices of comparable properties;
determining property value data from the public database, wherein the property value data includes the sales prices of comparable properties; and
determine the property value for the property using the property value data.

4. The system of claim 1, wherein the computing device performs the step of determining a property value boost for the property using the property value for the property and the property fitness index for the property, by:
determining a high range of the property value;
determining the property fitness index for the property is in a predetermined top range; and
determine the property value boost for the at least one property is the high range of the property value.

5. The system of claim 1, wherein the computing device performs the step of determining a property value boost for the property using the property value for the property and the property fitness index for the property, by:
determining a low range of the property value;
determining the property fitness index for the property is in a predetermined low range; and
determining the property value boost for the at least one property is one or more of: zero or in the low range of the property value.

6. The system of claim 1, wherein the computing device performs the step of determining a property value boost for the property using the property value for the property and the property fitness index for the property, by:
determining a midrange of the property value;
determining the property fitness index for the property is in a predetermined midrange; and
determining the property value boost for the at least one property is in a midrange of the property value.

7. The system of claim 1, wherein the computing device further performs the steps of:
accessing a profile of the at least one property stored in the non-transitory computer readable medium; and
determining from the profile at least one recommendation to increase the property value boost for the at least one property, wherein the at least one recommendation includes at least one of:
a safety recommendation;
a time sensitive recommendation; or
a recommendation to increase value of the property.

8. The system of claim 7, wherein the computing device further performs the step of:
generating a GUI to display the at least one recommendation on a screen.

9. The system of claim 7, wherein the computing device further performs the step of:
accessing at least one public database, wherein the at least one public database includes features of comparable properties;
determining a plurality of features of comparable properties;
comparing the plurality of features of the comparable properties to features of the property;
determining a missing feature in the property; and
generating a GUI with a recommendation to add the missing feature to the property.

10. The system of claim 1, wherein the computing device further performs the step of:
generating a report including the property value boost and one or more features of the property.

11. The system of claim 1, wherein the at east one fitness metric includes at least one of:
at least one behavior of the user within the at least one property,
a level of engagement of the user with the system,
at least one state of the property,
at least one trait of the property, and
combinations thereof.

12. A system for managing maintenance of at least one property, comprising: a computing device having a processing unit, the processing unit operatively coupled to a non-transitory computer readable medium, comprising instructions stored thereon, which, when executed by the processing unit, causes the computing device to perform the steps of:
determining a property fitness index of the at least one property;
determining a property value for the property and a range of the property value using property value data, wherein the property value data is obtained by one or more of: accessing at least one public database or receiving input from a user; and
determining a property value boost for the property using the property value for the property, the range for the property value and the property fitness index for the property.

13. The system of claim 12, wherein the computing device further performs the step of: generating a graphical user interface (GUI) for display including the property value boost for the property.

14. The system of claim 12, wherein the computing device performs the step of determining the property value for the property and the range of the property value using the property value data, by:
accessing the at least one public database using an application program interface (API), wherein the at least one public database includes sale prices of properties;
determining a plurality of sale prices of comparable properties from the at least one public database;
receiving the input from the user, wherein the input includes an estimated property value data for the property; and
determining the property value by calculating a mean or average of the plurality of sale prices of comparable properties and the estimated property value data.

15. The system of claim 13, wherein the computing device performs the steps of determining the property value for the property and the range of the property value using the property value data, by:
determining a plurality of differences between the property value and the plurality of sale prices of comparable properties; and
determining the range of the property value using the plurality of differences.

16. The system of claim 14, wherein the computing device performs the step of determining a property value boost for the property, by:
correlating the range of the property value to one or more thresholds in the property fitness index.

17. The system of claim 12, wherein the computing device further performs the steps of:
determining at least one recommendation to increase the property value boost for the at least one property, wherein the at least one recommendation includes at least one of:
a safety recommendation;
a time sensitive recommendation; or
a recommendation to increase value of the property.

18. The system of claim 17, wherein the computing device further performs the step of:
generating a GUI to display the at least one recommendation on a screen.

19. The system of claim 12, wherein the computing device further performs the step of:
generating a report including the property value boost and one or more features of the at least one property.

20. A system for managing maintenance of at least one property, comprising:
a computing device having a processing unit, the processing unit operatively coupled to a non-transitory computer readable medium, comprising instructions stored thereon, which, when executed by the processing unit, causes the computing device to perform the steps of:
determining user input into the system, wherein the user input indicates an action relating to a property; and
auto-populating a property log for the property with the action and an associated date for the action.

21. The system of claim 20, wherein the computing device further performs the step of:
generating a GUI of a historical report for the property, wherein the GUI includes a listing by date of at least the property maintenance action and the user notes relating to the property.

22. The system of claim 20, wherein the computing device performs the step of determining user input into the system by receiving a status message in response to user input of the action relating to the property.

23. The system of claim 22, wherein the user input may be input: directly into the home profile of the user; in response to a notification from the system that may be sent to the user via push notification, SMS text, or an alternate method; by recording information into a HomeLog or Journal; and combinations thereof.

24. The system of claim 20, wherein the computing device further performs the step of:
associating one or a plurality of categories to the action, wherein the plurality of categories includes at least: improvements, maintenance, and home issue.

25. The system of claim 20, wherein the computing device further performs the steps of: receiving a request to enter user notes relating to the property;
generating a GUI to enter text; and
receiving user notes relating to the property and storing the user notes with an associated date in the property log.

26. The system of claim 25, wherein the computing device further performs the step of: generating the GUI of the historical report for the property, wherein the GUI includes a listing by date of at least the property maintenance action and the user notes relating to the property.
